(19) United States
(12) Patent Application Publication
(10) Pub. No.: US 2025/0355752 A1
(43) Pub. Date: Nov. 20, 2025

(54) AUTOMATIC DIAGNOSTIC RESOLUTION SYSTEM

(71) Applicant: ASSURANT, INC., New York, NY (US)

(72) Inventor: Ronnie Blake PERKNA, Smyrna, GA (US)

(21) Appl. No.: 19/206,153

(22) Filed: May 13, 2025

Related U.S. Application Data
(60) Provisional application No. 63/647,255, filed on May 14, 2024.

(51) Int. Cl. G06F 11/07

(52) U.S. Cl. CPC G06F 11/079; G06F 11/0709; G06F 11/0793

(57) ABSTRACT

Embodiments of the present disclosure provide for transformation of diagnostic resolution data indicative of diagnostic identifiers associated with device faults. Example embodiments including a system configured to: receive diagnostic resolution data comprising one or more first diagnostic identifiers associated with one or more device faults; transform, via a mapping engine comprising a trained mapping model, the diagnostic resolution data into executable resolution data by mapping the one or more first diagnostic identifiers to at least one or more component identifiers; generating an execution instruction set, via an adjudication engine comprising an adjudication framework, based on the one or more component identifiers; and transmitting the execution instruction set to facilitate a resolution for the one or more device faults.

### CROSS REFERENCE TO RELATED APPLICATIONS

This application claims the benefit of priority to U.S. Provisional Application No. 63/647,255, filed May 14, 2024, the contents of which are incorporated by reference herein in their entirety for all purposes.

### TECHNOLOGICAL FIELD

Embodiments of the present disclosure generally relate to diagnosing and resolving device faults, including by automatic transformation of diagnostic resolution data and generation of execution instructions for resolution of device faults.

### BACKGROUND

Legacy systems for adjudicating and resolving device faults may be unreliable, inefficient, and ineffective in many ways. For example, attempts by a provider system to generate execution instructions for resolution of a device fault by a triage system may encounter a number of difficulties in obtaining accurate, timely data that is compatible with the legacy system, which may result in significant delays or inaccurate execution instructions. In some instances, different triage systems may be associated with different, often unknown or unclassified, data types and, as such, acquiring data for generation of execution instructions may be difficult or impractical when communication between multiple triage systems is required. Users may abandon existing systems in favor of analog alternatives or redundant ingestion may be required due to the inability of the aforementioned systems to electronically communicate to adjudicate and resolve such device faults. Applicant has discovered a number of additional problems with current implementations of such systems. Through applied effort, ingenuity, and innovation, Applicant has solved many of these identified problems by developing solutions that are embodied in the present disclosure, many examples of which are described in detail below.

### BRIEF SUMMARY

In general, embodiments of the present disclosure provided herein for automatic diagnostic resolution data transformation. Other implementations for automatic diagnostic resolution data transformation will be, or will become, apparent to one with skill in the art upon examination of the following figures and detailed description. It is intended that all such additional implementations be included within this description be within the scope of the disclosure, and be protected by the following claims.

In accordance with one example aspect of the present disclosure, a computer-implemented method is provided. The computer-implemented method may be implemented and/or otherwise executed via any of a myriad of computing devices, including device(s), apparatus(es), and/or system(s), described herein embodied in software, hardware, firmware, and/or a combination thereof. In one example computer-implemented method, the example computer-implemented method includes receiving diagnostic resolution data comprising one or more first diagnostic identifiers associated with one or more device faults. The example computer-implemented method further includes transforming, via a mapping engine comprising a trained mapping model, the diagnostic resolution data into executable resolution data by mapping the one or more first diagnostic identifiers to at least one or more component identifiers. The example computer-implemented method further includes generating an execution instruction set, via an adjudication engine comprising an adjudication framework, based on the one or more component identifiers. The example computer-implemented method further includes transmitting the execution instruction set to facilitate a resolution for the one or more device faults.

Additionally, or alternatively, in some embodiments of the example computer-implemented method, the example computer-implemented method further includes receiving an image comprising the one or more first diagnostic identifiers; and generating the diagnostic resolution data from the image using optical character recognition.

Additionally, or alternatively, in some embodiments of the example computer-implemented method, the example computer-implemented method further includes transmitting an application programming interface request to an endpoint of a first computing system associated with generating the one or more first diagnostic identifiers; and receiving the diagnostic resolution data in response to the application programming interface request to the endpoint of the first computing system.

Additionally, or alternatively, in some embodiments of the example computer-implemented method, the example computer-implemented method further includes obtaining a diagnostic session identifier associated with the one or more first diagnostic identifiers, wherein the application programming interface request comprises at least the diagnostic session identifier.

Additionally, or alternatively, in some embodiments of the example computer-implemented method, the example computer-implemented method further includes receiving, from a system user, an indication of a diagnostic session identifier or an image associated with a diagnostic session associated with the one or more device faults; and automatically triggering receipt of the diagnostic resolution data in response to receipt of the indication.

Additionally, or alternatively, in some embodiments of the example computer-implemented method, the example computer-implemented method further includes receiving, via a second domain, a request to initiate a transaction from a system user associated with a device experiencing the one or more device faults; and responsive to the request, triggering transmission of one or more electronic messages to the system user via a first domain or the second domain, wherein the one or more electronic messages comprise instructions pertaining to initiation of the transaction, and wherein reception of the diagnostic resolution data is based at least in part on transmission of the one or more electronic messages.

Additionally, or alternatively, in some such embodiments of the example computer-implemented method, at least one electronic message of the one or more electronic messages comprises a deep link transmitted to a computing device associated with the system user, the computing device being different than the device experiencing the one or more device faults.

Additionally, or alternatively, in some embodiments of the example computer-implemented method, the example computer-implemented method further includes triggering transmission of status information to the system user via the second domain, wherein the status information pertains to a status of the transaction.

Additionally, or alternatively, in some embodiments of the example computer-implemented method, the example computer-implemented method further includes transmitting a request to a system user associated with a device experiencing the one or more device faults based at least in part on a failure to map at least one diagnostic identifier of the one or more first diagnostic identifiers to a respective component identifier; receiving, from a system user, an indication of a diagnostic session identifier or an image associated with a diagnostic session associated with the one or more device faults; and substituting the at least one diagnostic identifier with the second diagnostic identifier in the diagnostic resolution data.

Additionally, or alternatively, in some embodiments of the example computer-implemented method, the example computer-implemented method further includes identifying a system user that corresponds to a device associated with the one or more device faults based at least in part on a comparison of user profile data with at least one component identifier of the one or more component identifiers, wherein the execution instruction set is based at least in part on the system user.

Additionally, or alternatively, in some such embodiments of the example computer-implemented method, the diagnostic resolution data comprises at least one of the following: data associated with resolving the one or more device faults, data associated with attempting to resolve the one or more device faults, data associated with attempting to prevent an occurrence of the one or more device faults, data associated with preventing one or more effects of the one or more device faults, or data associated with mitigate one or more effects of the one or more device faults.

Additionally, or alternatively, in some such embodiments of the example computer-implemented method, the one or more first diagnostic identifiers are mapped to the one or more component identifiers and one or more non-component identifiers.

Additionally, or alternatively, in some such embodiments of the example computer-implemented method, the one or more component identifiers correspond to one or more components of at least one device associated with the one or more device faults, and the one or more non-component identifiers correspond to at least one of the following: one or more operations performed in accordance with a resolution of the one or more device faults, one or more first parameters of a first system user associated with the at least one device, or one or more second parameters of a second system user associated with the resolution for the one or more device faults.

Additionally, or alternatively, in some such embodiments of the example computer-implemented method, the diagnostic resolution data comprises vehicular diagnostic resolution data generated based on one or more diagnostic measurements associated with a vehicle.

Additionally, or alternatively, in some embodiments of the example computer-implemented method, the example computer-implemented method further includes training a mapping model using structured historical diagnostic resolution data comprising a plurality of historical diagnostic identifiers, and historical executable resolution data comprising a plurality of component identifiers associated with the structured historical diagnostic resolution data to obtain the trained mapping model.

Additionally, or alternatively, in some such embodiments of the example computer-implemented method, the trained mapping model comprises at least one natural language processing model, and wherein transformation of the diagnostic resolution data into the executable resolution data is based at least in part on applying the diagnostic resolution data to the at least one natural language processing model using the mapping engine.

Additionally, or alternatively, in some such embodiments of the example computer-implemented method, the diagnostic resolution data comprises a plurality of diagnostic resolution data sets associated with a plurality of data types, and wherein the mapping engine maps each diagnostic resolution data set of the plurality of diagnostic resolution data sets to a plurality of executable resolution data sets in accordance with a respective data type of the plurality of data types.

Additionally, or alternatively, in some such embodiments of the example computer-implemented method, each component identifier of the one or more component identifiers are associated with a same data type, and where in the one or more device faults correspond to a first device.

Additionally, or alternatively, in some such embodiments of the example computer-implemented method, the adjudication engine comprises a preexisting adjudication engine, and wherein the mapping engine is configured to retrofit the preexisting adjudication engine to receive the diagnostic resolution data associated with a plurality of data types without modifying the preexisting adjudication engine.

In accordance with yet another aspect of the present disclosure, an apparatus is provided. In one example of the apparatus, the example apparatus includes at least one processor and at least one non-transitory memory storing computer-coded instructions thereon. The memory, via the computer-coded instructions in execution with the at least one processor, configures the example apparatus to perform any one of the example computer-implemented methods described herein.

In accordance with yet another aspect of the present disclosure, a computer program product is provided. In one example of the example computer program product, the example computer program product includes at least one non-transitory computer-readable storage medium having computer program code thereon. The computer-readable storage medium in execution with the at least one processor is configured for performing any one of the example computer-implemented methods described herein.

### BRIEF DESCRIPTION OF THE DRAWINGS

Having thus described the embodiments of the disclosure in general terms, reference now will be made to the accompanying drawings, which are not necessarily drawn to scale, and wherein:

FIG. 1 illustrates a block diagram of a system that may be specially configured within which embodiments of the present disclosure may operate;

FIG. 2 illustrates a block diagram of an example apparatus that may be specially configured to facilitate resolution of device faults in accordance with at least some example embodiments of the present disclosure;

FIG. 3 illustrates visualizations of example system specially configured to facilitate resolution of device faults in accordance with at least some example embodiments of the present disclosure;

FIG. 4 illustrates visualizations of example system specially configured to facilitate resolution of device faults in accordance with at least some example embodiments of the present disclosure;

FIG. 5 illustrates visualizations of example diagnostic resolution data specially configured to facilitate resolution of device faults in accordance with at least some example embodiments of the present disclosure;

FIG. 6 illustrates a data flow diagram between computing devices performing operations for an example process of generating execution instructions for resolution of device faults in accordance with at least some example embodiments of the present disclosure;

FIG. 7 illustrates a flowchart depicting operations of an example process for generating execution instructions for resolution of device faults in accordance with at least some example embodiments of the present disclosure.

### DETAILED DESCRIPTION

Embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements. Like numbers refer to like elements throughout.

In some embodiments, some of the operations above may be modified or further amplified. Furthermore, in some embodiments, additional optional operations may be included. Modifications, amplifications, or additions to the operations above may be performed in any order and in any combination.

### Overview

A triage system may identify one or more faults in a device associated with a protection product provided by a provider system. In diagnosing the one or more faults, the triage system may generate one or more sets of diagnostic resolution data including diagnostic identifiers indicative of the fault and/or the fault resolutions. An entity associated with the device, such as an owner of the device and/or owner of the protection product, may authorize the triage system to communicate with the provider system on behalf of the entity to facilitate a transaction of value in accordance with the protection product and in response to resolving the one or more device faults. The triage system may provide diagnostic resolution data to an adjudication engine. The adjudication engine may include an adjudication framework for generating execution instruction sets based at least in part on the diagnostic resolution data. The adjudication engine may, via the adjudication framework, generate an execution instruction set associated with a resolution for the one or more device faults. For example, the provider system may use the diagnostic resolution data to determine whether the one or more device faults satisfy criteria associated with the protection product. In some embodiments, the execution instruction set may include executable instructions for the triage system to execute the resolution for the one or more device faults.

Attempts by the provider system to generate execution instructions for resolutions of device faults may encounter a number of difficulties in obtaining accurate, timely diagnostic resolution data and enabling the adjudication engine to rapidly and consistently interpret the diagnostic resolution data. While the adjudication system may be configured to generate the execution instruction set using an adjudication engine based on the diagnostic resolution data, various triage systems may have different data types (e.g., lexicons) defining the diagnostic resolution data such that the adjudication engine is unable to interpret the diagnostic resolution data. For example, the adjudication engine may utilize an API or other programmatic interface for receiving inputs, and the data received from the triage system must be compatible with this interface. In some instances, preexisting mapping models may be used to transform the received diagnostic resolution data into executable resolution data in a standard format capable of being adjudicated by the adjudication engine (e.g., data comprising the correct API calls or other programmatic interface inputs that are processable by the adjudication engine). In some instances, the adjudication system may be a legacy adjudication system configured to adjudicate on data of only a standardized data type, which may be different from a data type associated with the diagnostic resolution data obtained from the triage system. In some instances, unknown triage systems with unknown data types may direct diagnostic resolution data to the provider system, which unknown data types may lack preexisting mapping models and/or the correct standard format for the adjudication engine.

Embodiments of the present disclosure include a mapping engine (e.g., a universal mapping engine) capable of transforming diagnostic resolution data into executable resolution data that is processable by the provider system adjudication engine. The mapping engine may include one or more mapping models, some of which may be trained machine learning models, capable of transforming the diagnostic resolution data of a plurality of data types (e.g., any data type in some disclosed embodiments) into executable resolution data configured for input into the adjudication engine. The adjudication system may be configured to adjudicate (e.g., auto-adjudicate) in accordance with the standardized format of the executable resolution data. Moreover, the mapping engine may be added onto a legacy adjudication engine as an additional layer to retrofit the existing adjudication engine to receive one or more new data types. In some embodiments, the mapping engine may learn new data types using various machine learning training techniques described herein.

For example, in some instances, the triage system may generate the diagnostic resolution data in accordance with a format that is incompatible with the adjudication system (e.g., not in the accepted, standardized format of the adjudication engine). Accordingly, in order to generate the execution instructions, the provider system must first obtain the diagnostic resolution data in accordance with the standardized format that is compatible with the adjudication system (e.g., the executable resolution data). Moreover, different triage systems may be associated with different data types and generating execution instructions based on different diagnostic resolution data sets from the different triage systems may be difficult or impractical, if not impossible. It may further be impossible to predict new data type mappings needed for unknown triage systems. Consequently, to obtain data for generation of execution instructions, users may abandon the automated provider system and/or the provider system may experience a failure necessitating manual hardcoding of the executable resolution data, leading to data inaccuracies and incorrect resolution instructions for the one or more device faults.

In some instances, the provider system may be configured to establish a direct or indirect link with the triage system (e.g., via one or more application programing interfaces (APIs) of the triage system and/or the provider system), such that the provider system may autonomously obtain (or otherwise generate) the diagnostic resolution data. The triage system may generate and store diagnostic resolution data in accordance with a data type that is associated with (e.g., specific to) the triage system, and the data type associated with the triage system may be different from the standardized data type associated with (e.g., specific to) the provider system. Thus, retrieval of the diagnostic resolution data via an API of the triage system may require mapping into the executable resolution data. Accordingly, in order to generate the execution instructions, the provider system may translate the diagnostic resolution data from the data type associated with the triage system into the standardized data type associated with the adjudication system using a mapping engine in accordance with various embodiments of the present disclosure.

Embodiments of the present disclosure relate to systems, methods, apparatuses, and related embodiments for automatic dynamic transformation (e.g., universal transformation) of diagnostic resolution data to enable generation of execution instructions for resolving device faults, such as by using the one or more mapping engine embodiments disclosed herein. Benefits of the embodiments of the present disclosure, which are described throughout the disclosure, include but are not limited to enabling automatic adjudication of device faults across a plurality of known and unknown triage systems, reducing reliance or elimination of human input, reducing redundancies related to diagnostic resolution data submission (e.g., reducing network bandwidth and data efficiency and accuracy), and improving diagnostic resolution accuracy of device faults. In some embodiments, specific examples of diagnostic resolution data and related devices, systems, algorithms, methods, and the like are described, such as a vehicular diagnostic resolution data generated by a triage system associated with a vehicle, such as based on vehicle telemetry data and diagnostics run on vehicle telemetry data; however, it should be understood by the person of ordinary skill in the art in light of the present disclosure that the specific examples are provided to illustrate non-limiting examples of the functionality of the underlying systems, methods, apparatuses, and related embodiments and the scope of the embodiments are not strictly limited to their context. For example, teachings described herein with respect to vehicular diagnostic resolution data may be equally applied to and claimed as part of service application systems associated with any other faulty device, such as smartphones, personal computers, tablets, home appliances, and the like utilizing a provider system and adjudication system as described herein. Likewise, reference herein to “vehicles” and the like may be substituted for any other subject that may be associated with a protection product.

In various embodiments, a provider system for vehicular protection products may include examples of the systems, methods, apparatuses, and related embodiments for generating execution instructions for device faults (e.g., vehicle faults) are described herein. Vehicles may be serviced by various triage systems, such as by dealerships or independent repair facilities (IRFs) executing repairs based on vehicle telemetry data and other diagnostic information, for purposes of repairing, maintaining, and/or servicing a vehicle. Often, such triage systems lack a robust information technology infrastructure, causing triage systems to often lack the ability to effectively process information associated with device faults for coordination with provider systems (e.g., via incompatible data types, data ingestion problems, and the like). Even where information technology infrastructures are adequate, factors such as differences in data structures (e.g., data types) among different triage systems may make large scale, multi-triage systems impractical for a provider system, particularly where provider systems must interact with many, new, or unknown triage systems across a network or networks of triage systems. For example, triage systems may use different data types for the same component (e.g., due to internal preferences or due to obtaining the component from different manufacturers) and the provider system may be unable to decipher the different data types to a standardized data type, which is used by the provider system for generation of execution instructions. In some particular instances, the provider system may be unable to extract component identifiers from the diagnostic resolution data without the benefit of the mapping engine(s) described herein. Moreover, some triage systems use a computing systems to maintain diagnostic resolution data associated with device faults, however such systems may include several customizations which are challenging for provider systems to integrate with. For example, different computing systems may have different configurations for diagnostic resolution data and/or different triage systems may use different data types within a same computing system, necessitating increased processing of the diagnostic resolution data by the service provider and/or causing abandonment or other failure of the adjudication engine.

In some instances, provider systems may redirect users (e.g., triage system users) to more efficient communication domains. For example, provider systems may employ a primary domain (e.g., a primary channel of communication, such as an electronic messaging platform, API, software application, or the like), within which the triage system transmits or permits retrieval of diagnostic resolution data associated with the device faults. Without the benefit of the embodiments of the present disclosure, triage systems or users thereof are unable to transmit diagnostic resolution data consistently or accurately over the primary domain and either due to errors or outright failure of the provider system to receive or interpret the diagnostic resolution data. Users unable to access the primary domain or for whom the primary domain fails must resort to slower, less accurate (e.g., manual and/or telephonic) transmission of data between the triage system and the provider system. For example, the triage system may instead use non-primary domains (e.g., secondary domains, non-primary channels of communication), such as telephone calls, to communicate the diagnostic resolution data to the provider system. Communication via non-primary domains may, however, be time consuming and not allow direct mapping of the triage system data type into the standard data type for the provider system. Instead, without the benefit of the present disclosure, a provider system and/or triage system may be required to generate the diagnostic resolution data in duplicate, once in the data type of the triage system and a second time in the standardized data type (e.g., as executable resolution data), and even then, only in such instances where the triage system data type is known and transformable. The non-primary domains and/or dual data generation prohibit flexibility and scaling of the provider system and connectivity between the provider system and triage systems facilitated by the universal mapping engine and associated embodiments discussed herein. These problems may be exacerbated when time is of the essence, such as when a triage system is attempting to repair a vehicle and/or when the provider system is coordinating resolutions with a large quantity of triage systems.

Various embodiments provided herein enable a provider system to automatically transform diagnostic resolution data from any triage system, even in instances in which a triage system generates diagnostic resolution data in accordance with a format and/or data type that is incompatible with the provider system, and including new, unknown triage systems with unknown data types to facilitate repair of the device. For example, a customer of a provider system may interact with a triage system for purposes of repairing, maintaining, and/or servicing a vehicle. The triage system may perform one or more diagnostic measurements on the vehicle (e.g., directly, via a vehicle telematics system, or the like) and generate diagnostic resolution data (e.g., generate a repair order comprising diagnostic information) based on the diagnostic measurements. The diagnostic resolution data includes one or more diagnostic identifiers associated with one or more device faults identified via the one or more diagnostic measurements. In some embodiments, the diagnostic identifiers may include data indicative of component identifiers and/or non-component identifiers.

In some embodiments, the provider system may obtain a limited set of information from the triage system, for example, including at least an identifier associated with a session for generating the diagnostic resolution data (e.g., repair order number). Such data is usable to initiate generation of an execution instruction set for a resolution of the one or more device faults. For example, in some embodiments, the triage system generates the diagnostic resolution data using a computing system and/or otherwise inputs the diagnostic resolution data to the computing system. The triage system may authorize the provider system to use the number to autonomously retrieve (e.g., directly or via a third-party integration system) the diagnostic resolution data from the computing system, such as via one or more APIs. In some other embodiments, such as embodiments in which the triage system does not use a computing system (or the provider system is not authorized to retrieve data from the computing system), the provider system may obtain an image of a document embodying the diagnostic resolution data (e.g., the repair order) from the triage system and, for example, use optical character recognition (OCR) or other techniques to autonomously obtain the diagnostic resolution data from the image. By obtaining the diagnostic repair information via the one or more of the aforementioned techniques, the provider system reduces a redundancy of data submissions, ingestion, transformation, and the like, as well as reduces the frequency of communication to the provider system via non-primary domains.

In some embodiments, the provider system may use artificial intelligence (e.g., one or more trained machine learning models) to map the diagnostic identifiers included in the obtained diagnostic resolution data to component and/or non-component identifiers, which are associated with the standardized data type to generate the executable resolution data. For example, the provider system may include a mapping engine, which uses a trained mapping model (e.g., one or more trained machine learning models) to transform the diagnostic resolution data obtained from the triage system into executable resolution data by mapping the one or more diagnostic identifiers to the one or more component and/or non-component identifiers. In some embodiments, the provider system may train the mapping model on diagnostic resolution data from different triage systems, which include different diagnostic identifiers in different data types. Additionally, the provider system may train the mapping model on component and non-component identifiers from one or more external service system(s) (e.g., manufactures of components), which may improve an accuracy of the trained mapping model. In some embodiments, the provider system may use the one or more component and/or non-component identifiers to generate an execution instruction set and facilitate a resolution for the one or more device faults. By using the mapping engine to map the diagnostic identifiers to the one or more component and non-component identifiers, the provider system may reduce errors and improve an accuracy of the execution instruction set. Moreover, the trained mapping model may be configured to predict the component identifiers and/or non-component identifiers from the diagnostic resolution data set of an unknown or new triage system based on the aforementioned training.

The above-described embodiments and examples are equally applicable in other contexts, which are fully contemplated by the disclosure herein. For example, a provider system may be configured with protection products capable of facilitating fault resolution and executable instruction set generation for other types of devices, such as IoT devices and appliances for homes or other types of devices, may seek to generate execution instructions using the same processes described herein, in which the system provider transforms diagnostic resolution data into executable resolution data for generation of an execution instruction set.

The embodiments described herein relating to a “vehicle” are provided to give the aforementioned context for an example environment in which the service application and associated systems, methods, apparatuses, and related embodiments operate but should not be construed as necessarily limiting the generality of the systems, methods, apparatuses, and related embodiments disclosed.

### Definitions

The term “diagnostic resolution data” refers to any data representation associated with resolving or attempting to resolve one or more device faults or to prevent or attempt to prevent the occurrence of and/or mitigate the effects of one or more device faults. Diagnostic resolution data may include one or more diagnostic identifiers. Diagnostic resolution data may be generated via any method, including but not limited to generating one or more diagnostic identifiers via optical character recognition (OCR) of one or more documents and/or one or more diagnostic identifiers retrieved via an application programming interface (API) request from a computing system endpoint.

The term “diagnostic identifier” refers to individual datum indicative of a resolution to a device fault or a preventative measure configured to prevent or attempt to mitigate the effects of a device fault. A diagnostic identifier may include a diagnostic measurement and/or information derived from a diagnostic measurement, including analyses or resolution recommendations for resolving a device fault (e.g., a device fault detected via the diagnostic measurements). In some embodiments, a diagnostic identifier may include prophylactic information, whether predetermined or generated based on one or more diagnostic measurements or other information, configured to prevent the occurrence of a device fault and/or mitigate the effects of a detected or potential device fault. In some embodiments, a diagnostic identifier may be generated at least partly by a processor associated with a device, whether onboard or remote from the device. In some embodiments, a diagnostic identifier may be input by a user in response to diagnostic measurements or other information. A diagnostic identifier may include information directly or indirectly representative of a component (e.g., part, assembly, sub-assembly, additive, or the like) associated with the device. A diagnostic identifier may include (e.g., identify) one or more actions, whether already executed or recommended to be executed, associated with the device. In some embodiments, the diagnostic identifier may include one or more actions defining at least a portion of a resolution to a device fault or a preventative measure configured to prevent or attempt to mitigate the effects of a device fault. For example, a diagnostic identifier may include one or more actions utilized for addressing one or more aspects of a functionality of a device. Some such actions may include, for example, replacing, adding to, or otherwise modifying the device or a component of the device. Non-limiting examples of a diagnostic identifier may include a data value indicative of a device fault (e.g., “engine cranks but no start”, “door latch freezing concerns”, etc.), a data value indicative of a resolution to a device fault (e.g., “powertrain control module reprogramming”), a data value configured to prevent a device fault (e.g., “multi point inspection”), a data value corresponding to an entity associated with the device or the component thereof, a data value corresponding to an entity associated with the resolution for the device, or other diagnostic data values.

Non-limiting examples of a data value corresponding to a resolution for a device include a data value corresponding to an identified or predicted fault associated with a functionality of the device, a data value corresponding to an action or quantity of time associated with identifying or predicting the fault, a data value corresponding to an action or quantity of time associated with resolving the identified or predicted fault, a data value corresponding to an action or quantity of time associated with determining a level of performance associated with a functionality of the device, or a data value corresponding to an action or quantity of time associated with maintaining or improving the determined level of performance.

A data value corresponding to a device, or a component thereof may include one or more properties associated with the device or the component thereof. Non-limiting examples of such data values include some or all of a serial number or other identification number (e.g., a VIN), a device make, a device model, a device third party identifier (e.g., a dealer or repair provider identifier), vehicle lifespan data (e.g., vehicle mileage values), a date code, a logo, and/or other identifying or characterizing information.

An entity associated with a device may include an owner or user of the device and/or a protection product for the device. Non-limiting examples of a data value corresponding to such an entity include a first name, a last name, a phone number, an email, a natural person identifier (e.g., a social security number), a protection product associated with the entity, and/or an entity identifier.

The term “device fault” refers to an actual, predicted, or potential failure of a device or component thereof (e.g., failure to perform an expected or intended operation); a deviation from an expected or intended operation of a device; and/or any other abnormality that impacts a function or perceived function of the device or a component thereof. Non-limiting examples of a device fault include a hardware fault, a software fault, a mechanical fault, or an electrical fault.

The term “diagnostic measurement” refers to an action performed to obtain data associated with one or more diagnostic indicators. A diagnostic measurement may include sensor data or other programmatic data obtained from computing components associated with a device or computing components observing the device. A diagnostic measurement may include data input by a user based on such actions or observations. A diagnostic measurement may be usable for identifying or predicting a device fault associated with a device or for determining a level of performance associated with the device. Non-limiting examples of a diagnostic measurement include an on-board diagnostics scan, a compression test, a fuel system pressure test, an ignition system inspection, a visual inspection or road test, a dynamometer test, a break performance test, a suspension and handling evaluation, a fuel economy analysis, collection of electronic telemetric data, or an electrical system test. In one non-limiting example, a device may autonomously perform one or more measurements to detect a device fault and, in response to detection of the device fault, may trigger output of an error code. In such an example, an entity associated with a resolution for the device fault may generate a resolution and/or diagnostic resolution data based on an analysts of the error code. In one non-limiting example, the entity may use one or more models to analyze the error code and/or generate a resolution and/or diagnostic resolution data associated therewith. In one non-limiting example, one or more diagnostic measurement may be performed on a device or autonomously by the device to identify (or in response to identifying) one or more device faults.

The term “protection product” refers to a policy, contract, service, or other product that provides for the protection, coverage, maintenance, and/or repair of devices or services associated with devices. Non-limiting examples of protection products include vehicle extended protection plan information, insurance plan information, GAP insurance plan information, tire and wheel coverage plan information, prepaid maintenance plan information, an appearance protection product, a factory warranty protection product, a theft protection product; a 3-for-1 protection product, and the like.

An entity associated with a resolution for a device may include a person, business, corporation, and/or other identifiable entity that engages or desires to engage one or more customers that own or use the device. Non-limiting examples of such an entity include a person, business, corporation, and/or other identifiable entity that deals in the sale, service, maintenance, offloading, and/or other provision of devices or services associated with devices to one or more customers, such as a vehicle dealership, a vehicle manufacturer, a service advisor, a dealer management system, or an independent repair facility.

The term “system user” refers to a person, business, corporation, and/or other identifiable entity that transacts and/or otherwise interacts with a provider system. In some embodiments, for example, a system user may engage with a provider system, such as by subscribing, maintaining, or otherwise using a protection product. In some such embodiments, the system user is a customer of the provider system. In some other embodiments, a system user may engage with a provider system to facilitate use of a protection product. In some such embodiment, the system user is, or is otherwise associated with, a triage system.

The term “data type” refers to a lexicon, format, or other non-substantive feature associated with one or more data values. In some embodiments, data type may include different combinations of multiple data values. Diagnostic resolution data may be associated with one or more data types. For example, diagnostic resolution data may include multiple diagnostic resolution data sets associated with multiple (e.g., different) data types. In some examples, a data type associated with a data value may be based on a source of the data value. In some non-limiting examples, a source of the data value includes a triage system. For example, a system may obtain a diagnostic resolution data set from a source and the diagnostic data set may include one or more data values (e.g., one or more diagnostic identifiers) having a data type that is associated with the source. In some examples, multiple sources may be associated with multiple (e.g., different) data types. For example, a first diagnostic identifier from a first source and a second diagnostic identifier from a second source may correspond to a same component of a device and/or a same non-component information (e.g., action) associated with a device. In such an example, the first diagnostic identifier may include a first data value of a first data type (associated with the first source) and the second diagnostic identifier may include a second data value of a second data type (associated with the second source), in which the first data type is different from the second data type. In other non-limiting example, the first data value may include a first term for the component of the device and the second data value may include a second term for the component of the device. Non-limiting examples of a source of a diagnostic identifier (e.g., data value) include a person, business, corporation, and/or other identifiable entity that deals in the sale, service, maintenance, offloading, and/or other provision of devices or services associated with devices to one or more customers, such as a vehicle dealership, a vehicle manufacturer, a service advisor, a dealer management system, or an independent repair facility. In an example embodiment, a first data type may include a diagnostic indicator having one or more data values indicative of a combination of a component and non-component data value that, when transformed into a second data type, generates one component indicator and one non-component indicator.

The term “mapping engine” refers to one or more computer executable instructions that configure one or more processors to execute a trained mapping model to transform the diagnostic resolution data into executable resolution data. For example, the mapping engine may be configured to execute the trained mapping model to transform one or more diagnostic identifiers from diagnostic resolution data into one or more component identifiers. A mapping engine may employ machine learning and utilize a mapping model to analyze and interpret patterns within diagnostic identifiers (input data values) associated with various data types, such that the mapping engine may map diagnostic identifiers of varying data types to one or more other identifiers associated with a single data type. The one or more other identifiers may include component identifiers or non-component identifiers. In one non-limiting example, a mapping engine uses a transformer model (e.g., a transformer neural network) to perform natural language processing (NPL) tasks.

In some examples, a mapping engine may utilize multiple mapping models associated with multiple data types. In some such examples, a system may configure the mapping engine (or the mapping engine may autonomously select) a mapping model based on a data type associated with a diagnostic identifier. In some embodiments, the mapping engine may include a preprocessor configured to analyze and identify a source and/or data type associated with a set of diagnostic resolution data to identify a model or particular input to a model that will allow the mapping engine to operate on diagnostic resolution data having the identified source and/or data type. Additionally, or alternatively, in some examples, a mapping engine may be configured to identify a source of a diagnostic identifier based on a data type associated with the diagnostic identifier.

The term “mapping model” refers to one or more computational algorithms or other processes configured to transform diagnostic resolution data into executable resolution data. For example, the mapping model may be configured to transform one or more diagnostic identifiers from diagnostic resolution data into one or more component identifiers. transform diagnostic identifiers into component identifiers in a standardized data type. A non-limiting example of a mapping model includes a transformer neural network utilized for natural language processing tasks performed by a mapping engine.

The mapping model may be trained to perform the transformation (e.g., a “trained mapping model”), such as using machine learning training algorithms on one or more sets of input data values (e.g., datasets, which may include diagnostic identifiers associated with various data types) to learn to identify correlations and mappings between data values of different data types and map them to a predefined (common) data type. The mapping model may be trained using structured or unstructured data. For example, a mapping engine may utilize a trained mapping model to map diagnostic identifiers associated with varying data types to one or more other identifiers associated with a single data type (e.g., a single lexicon). The one or more other identifiers may include component identifiers or non-component identifiers. A mapping model may be trained on multiple diagnostic identifier sets from multiple sources associated with multiple (e.g., different) data types.

The term “component identifier” refers to a data value corresponding to a device or a component thereof. A component identifier may represent one or more properties associated with the device or a component thereof, such as some or all of a VIN, a vehicle manufacturer (e.g., vehicle make), a vehicle model, a vehicle dealer identifier, vehicle mileage values, a serial numbers, a date code, a logo, and/or other identifying or characterizing information.

The term “non-component identifiers” refers to any data value other than a component identifier that is associated with a resolution for a device. Non-limiting examples of a non-component identifier include a data value corresponding to a resolution for a device, a data value corresponding to an entity associated with the device or the component thereof, or a data value corresponding to an entity associated with the resolution for the device.

The term “executable resolution data” refers to any data representation associated with resolving or attempting to resolve one or more device faults or to prevent or attempt to prevent the occurrence of and/or mitigate the effects of one or more device faults having a standardized data type associated with a provider system. The provider system may utilize the data values associated with the executable resolution data (e.g., at least one or more component identifiers and/or at least one or more non-component identifiers) to execute one or more operations, such as adjudication. In one non-limiting example, executable resolution data includes component identifiers and/or non-component identifiers associated with the same data type.

The term “execution instruction set” refers to instructions configured to facilitate a resolution for a device. In one non-limiting example, an execution instruction set includes instructions to perform the resolution for the device. In another non-limiting example, an execution instruction set includes instructions to refrain from performing the resolution for the device. In some non-limiting examples, an execution instruction set includes information indicative of one or more aspects of a protection product associated with the device.

The term “adjudication engine” refers to one or more computer executable instructions that configure one or more processors to generate an execution instruction set from executable resolution data. In some embodiments, the adjudication engine may generate the execution instruction set based on one or more component identifiers of the execution instruction set. The adjudication engine may employ machine learning and utilize an adjudication framework to analyze identifiers and generate execution instruction sets. In one non-limiting example, an adjudication engine is configured to utilize an adjudication framework to compare component and/or non-component identifiers with user profile data associated with a system user. A non-limiting example of a system user includes an entity associated with a device, such as an owner and/or user of the device or a protection product for the device. In some embodiments, the adjudication engine may be configured to analyze executable resolution data with a model (e.g., a rule set, algorithm, or the like) to generate the execution instruction set. The execution instruction set may be generated via any of a number of means, including retrieving predefined data from non-transitory computer readable memory, assembling the instruction set from a plurality of predefined data and/or variable data values, via generative artificial intelligence (e.g., a large language model) based on the executable resolution data, or the like.

The term “adjudication framework” refers to one or more rules or procedures for determining a type of adjudication to perform for one or more component identifiers and/or one or more rules or procedures for performing adjudication of the one or more component identifiers in accordance with the determined type of adjudication.

The term “preexisting adjudication engine” refers to a legacy adjudication system that is configured to adjudicate diagnostic resolution data associated with a single data type (e.g., a standardized data type).

The term “application programming interface (API) request” refers to a message that is transmitted from a first software application to a second software application and allows the first software application to request data or services from the second software application. An API request may also be referred to as an API call. Non-limiting examples of an API request include GET, POST, PUT, PATCH, and DELETE.

The term “diagnostic session identifier” refers to a data value that identifies or facilitates identification of a set of diagnostic resolution data. In some embodiments, a diagnostic session identifier may comprise an identifier associated with a particular device and/or a particular session or sessions during which the diagnostic resolution data was generated. In some embodiments, a diagnostic session identifier is computer readable data configured to allow a computing system to retrieve the diagnostic resolution data from a database. A diagnostic session identifier may be associated with a session for identifying or performing a resolution for a device. In some non-limiting examples, a diagnostic session identifier includes a first data value usable for requesting a second data value from an entity associated with the resolution for the device, in which the second data value corresponds to the session. In some other non-limiting examples, a diagnostic session identifier corresponds to the session. In some such examples, the diagnostic session identifier includes a number of a repair order.

The term “domain,” and the like, refers to a data communication pathway through which information is transmitted between individuals or entities. In some non-limiting examples, a domain includes a communication pathway associated with one or more computing devices that enables transmission of data between two or more computing devices. A domain may be characterized by a respective set of characteristics, constraints, and protocols governing the exchange of messages via the domain. Non-limiting examples of a domain include a telephone call, a SMS (Short Message Service) message, and an email. Connections between two different devices may be considered a separate domain even if there is overlap between the data communication pathways (e.g., a message between party A and party B may be considered a different domain than a message between party A and party C regardless of whether parties A, B, and C are connected to the same internet connection or use the same or different internet protocols). In some embodiments, a domain enables communication between a provider system and a triage system.

The term “status information” refers to information indicative of a status of a transaction. Non-limiting examples of status information include information pertaining to processing of diagnostic resolution data, information pertaining to diagnostic identifiers included in the diagnostic resolution data, information pertaining to component identifiers and/or non-component identifiers mapped to the diagnostic identifiers, information pertaining to an execution instruction set associated with the component and/or non-component identifiers, and requests for information pertaining to the diagnostic resolution data, the diagnostic identifiers, the component and/or non-component identifiers, or the execution instruction set.

The term “user terminal” refers to one or more computing devices embodied in hardware, software, firmware, and/or a combination thereof, for use by a particular customer or agent associated therewith. Non-limiting examples of a user terminal include a mobile device, a smartphone, a tablet, a personal computer, a laptop, a wearable, and an enterprise terminal.

The term “device” refers to the subject of one or more diagnostic measurements and/or diagnostic resolution data. Non-limiting examples of a device may include a mobile device, such as a laptop, smartphone, tablet, or the like; a non-mobile computing device, such as a desktop computer, server, or the like; vehicles, such as automobiles. Example embodiments herein may refer specifically to vehicles for ease of understanding, and it is to be understood that such descriptions are merely examples which may be adapted to any other device type unless noted otherwise.

### Example Systems of the Disclosure

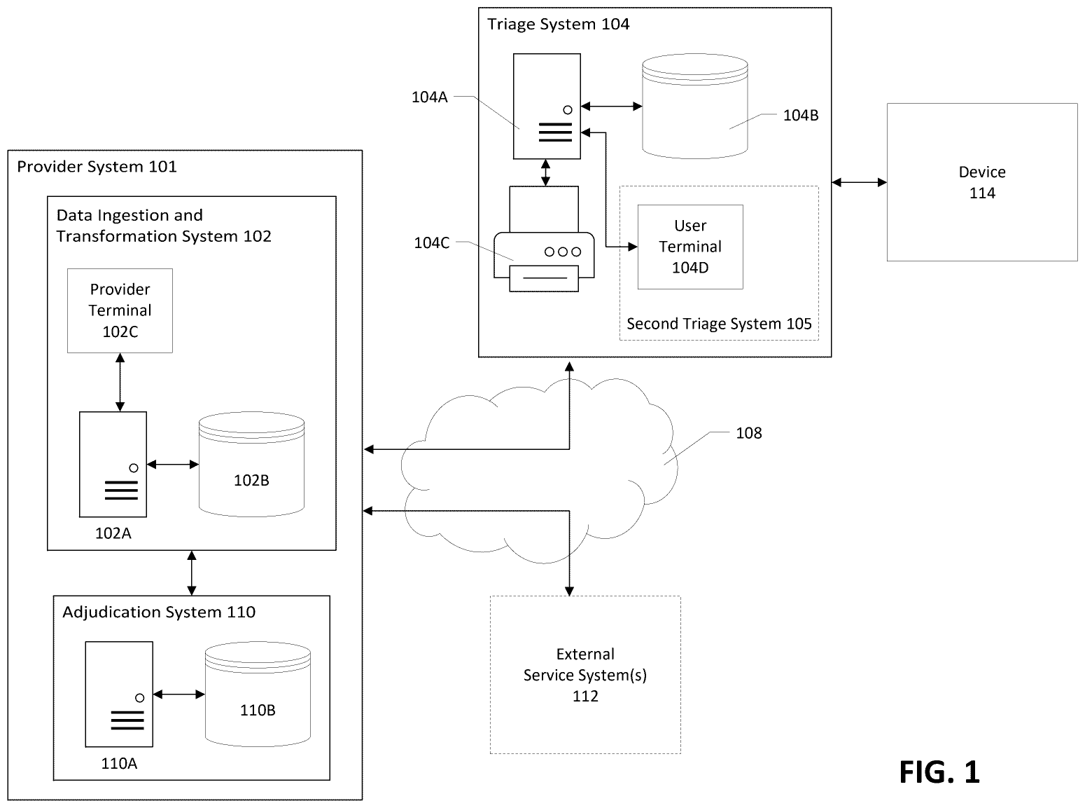

FIG. 1 illustrates an example system comprising a provider system 101, a data ingestion and transformation system 102, an adjudication system 110, a triage system 104, and a device 114 in accordance with example embodiments of the present disclosure. The depicted system includes communication links between the provider system 101 (e.g., the data ingestion and transformation system 102) and the triage system 104, and between the provider system 101 (e.g., the data ingestion and transformation system 102, the adjudication system 110) and one or more external service systems 112, over at least one communications network 108. In other embodiments, the provider system 101 communicates with the triage system 104 over a first communications network, and the provider system 101 communicates with the external service system(s) 112 over one or more second communications networks. The various systems and devices depicted in FIG. 1 communicate to facilitate the functionality described herein.

The depicted provider system 101 includes the data ingestion and transformation system 102, which may include the mapping engine, and the adjudication system 110, which may include the adjudication engine. As depicted, the data ingestion and transformation system 102 is communicable with the adjudication system 110. The data ingestion and transformation system 102 includes a data ingestion and transformation server 102A, a provider terminal 102C, and data ingestion and transformation data repository 102B. The data ingestion and transformation server 102A is communicable with the data ingestion and transformation data repository 102B and the provider terminal 102C. In some embodiments, the data ingestion and transformation server 102A is directly coupled to the data ingestion and transformation data repository 102B and/or provider terminal 102C, for example by wiring within the data ingestion and transformation system 102. Alternatively or additionally, in some embodiments, the data ingestion and transformation server 102A is wirelessly coupled to the data ingestion and transformation data repository 102B and/or the provider terminal 102C. In yet other embodiments, the data ingestion and transformation data repository 102B is embodied as a sub-system of the data ingestion and transformation server 102A. Alternatively or additionally, in some embodiments, the data ingestion and transformation data repository 102B is embodied as a virtual repository executing on the data ingestion and transformation server 102A.

The data ingestion and transformation data repository 102B embodies one or more computing devices configured to store any of the various data processed by the data ingestion and transformation server 102A to provide the functionality described as performed by the data ingestion and transformation system 102. The data ingestion and transformation data repository 102B may store various data in any of a myriad of manners, formats, tables, computing devices, and/or the like. For example, in some embodiments, the data ingestion and transformation data repository 102B includes one or more sub-repositories that are configured to store specific data processed by the data ingestion and transformation server 102A to provide the functionality described as performed by the data ingestion and transformation system 102. In some embodiments, the data ingestion and transformation system 102 may operate as a universal data preconditioner for transforming the triage system data into the standardized format recognizable and automatically actionable by the adjudication system.

In some embodiments, the data ingestion and transformation server 102A is configured to store specific data being processed to the data ingestion and transformation data repository 102B. For example, in some embodiments, the data ingestion and transformation server 102A stores data included in and/or based on executable resolution data, such as diagnostic resolution data, data types, diagnostic identifier(s), user profile data, component identifier(s), non-component identifier(s), a mapping engine (e.g., software), trained mapping model(s), associations between diagnostic resolution data, diagnostic identifier(s), user profile data, component identifier(s), non-component identifier(s), a mapping engine (e.g., software), and trained mapping model(s), and/or the like.

The adjudication system 110 includes an adjudication server 110A and an adjudication data repository 110B, which is communicable with the adjudication server 110A. In some embodiments, the adjudication server 110A is directly coupled to the adjudication data repository 110B, for example by wiring within the adjudication server 110A. Alternatively or additionally, in some embodiments, adjudication server 110A is wirelessly coupled to the adjudication data repository 110B. In yet other embodiments, the adjudication data repository 110B is embodied as a sub-system of the adjudication server 110A. Alternatively or additionally, in some embodiments, the adjudication data repository 110B is embodied as a virtual repository executing on the adjudication server 110A.

The adjudication data repository 110B embodies one or more computing devices configured to store any of the various data processed by the adjudication data repository 110B to provide the functionality described as performed by the adjudication system 110. The adjudication data repository 110B may store various data in any of a myriad of manners, formats, tables, computing devices, and/or the like. For example, in some embodiments, the adjudication data repository 110B includes one or more sub-repositories that are configured to store specific data processed by the adjudication server 110A.

In some embodiments, the adjudication server 110A is configured to store specific data being processed to the adjudication data repository 110B. For example, in some embodiments, the adjudication server 110A stores data generated included in and/or based on execution instructions, such as executable resolution data, user profile data, component identifier(s), non-component identifier(s), an adjudication engine, and trained mapping model(s) data object(s), associations between executable resolution data, user profile data, component identifier(s), non-component identifier(s), an adjudication engine, an adjudication framework, and trained mapping model(s) data object(s), and/or the like.

In some embodiments, the provider system 101 embodies or is associated with one or more software applications, in which the data ingestion and transformation system 102 and the adjudication system 110 correspond to data and infrastructure (e.g., back-end components) associated with and configured to execute one or more functionalities of the software application (e.g., a user portal, an electronic messaging platform). For example, in some embodiments, the data ingestion and transformation system 102 and the adjudication system 110 (and the components thereof) are communicable and configured to dynamically switch between different domains for communication with various entities, such as triage systems, customers, external service system(s) 112, and/or the like. In one non-limiting example, the data ingestion and transformation system 102 may be in communication with an entity of the triage system 104 via a first domain and, in response to a request from the entity, may dynamically switch to communicating with the entity via a secondary domain, for example, to receive diagnostic resolution data from or transit execution instructions to the entity. In some embodiments, each domain may use the network 108. In other embodiments, one or more domains (e.g., the primary domain) may use the network 108 while other domains use one or more secondary networks.

The external service system(s) 112 each include one or more computing device(s) embodied in hardware, software, firmware, and/or a combination thereof, that provide one or more vehicle-related service(s) and/or associated functionality. In some embodiments within a vehicle context, an external service system of the external service system(s) 112 embodies a back-end computing system supporting operations of a vehicle service provider, for example a repair shop, a body shop, an auto dealer, and/or the like. Each of the external service system(s) 112 may embody a system separate from the provider system 102 and/or the triage system 104. Additionally, or alternatively, in some embodiments different entities control any of the external service system(s) 112. In some non-limiting examples, an external service system 112 is associated with one or more diagnostic identifiers in one or more data types. For example, the provider system 101 may obtain diagnostic resolution data (e.g., one or more diagnostic identifiers) from the external service system(s) 112 and/or one or more triage systems, such as the triage system 104, which may each use a particular one or more data types (e.g., may use a particular lexicon). Accordingly, the provider system 101 may obtain diagnostic resolution data from the external service system(s) 112 and/or one or more triage systems, such that the provider system 101 may train one or more mapping models on multiple (different) data types. In some embodiments, a data type may be associated (e.g., linked with the provider system) with a respective identifier associated with one or more external service systems and/or triage systems, such that the provider system 101 (e.g., a mapping engine within the provider system 101) may use the identifier to weight and/or provide context to the mapping model or to select a particular mapping model for diagnostic resolution data from the corresponding external service system and/or triage system.

The triage system 104 includes a triage server 104A, as well as a triage data repository 104B, a user terminal 104D, and a medium printer 104C that are each communicable with the triage server 104A. In some embodiments, the triage server 104A is directly coupled to the triage data repository 104B, the user terminal 104, and the medium printer 104C, for example by wiring within the triage system 104. Alternatively or additionally, in some embodiments, the triage server 104A is wirelessly coupled to the triage data repository 104B, the user terminal 104, and the medium printer 104C. In yet other embodiments, the triage data repository 104B, the user terminal 104, and the medium printer 104C are embodied as sub-systems of the triage server 104A. In some embodiments, the triage data repository 104B is embodied as a virtual repository executing on the triage server 104A. While only single instances of the various systems are shown, it would be understood that multiple systems may be connected and interact without departing from the scope of the present disclosure (e.g., multiple triage systems 104 interacting with the provider system 101).

In some embodiments, the user terminal 104D may be associated with a second triage system 105, which may be separate from the triage system 104. For example, in some embodiments, the user terminal 104D may be associated with an independent repair facility (e.g., the second triage system 105) and the triage system 104 may correspond to a computing system, which the independent repair facility uses to maintain data, such as diagnostic resolution data (e.g., the triage system 104 may be or otherwise be associated with a dealer management system). In such an example, the user terminal 104D may directly communicate diagnostic resolution data to the provider system 102 and/or may communicate diagnostic resolution data to the provider system via the triage system 104 (e.g., via the triage server 104A). In some other embodiments, the user terminal 104D may be associated with (e.g., part of, included in) the triage system 104. For instance, in one non-limiting example, the triage system 104 may be an original equipment manufacturer (e.g., a vehicle manufacture) and the user terminal 104D may be associated with a dealership of the original equipment manufacturer. The user terminal 104D may include a camera and may be capable of capturing at least a portion of the diagnostic identifiers of the diagnostic resolution data in image data. In some embodiments, the user terminal 104D may be instantiated as software in a user's smartphone or other computing device.

The triage data repository 104B embodies one or more computing devices configured to store any of the various data processed by the triage server 104A to provide the functionality described as performed by the triage system 104. The triage data repository 104B may store various data in any of a myriad of manners, formats, tables, computing devices, and/or the like. For example, in some embodiments, the triage data repository 104B includes one or more sub-repositories that are configured to store specific data processed by triage server 104A to provide the functionality described as performed by the triage system 104. In some embodiments, the triage server 104A is configured to store specific data being processed to the triage data repository 104B. For example, in some embodiments, the triage server 104A stores data generated included in and/or based on diagnostic resolution data, such as diagnostic identifier(s).

The triage server 104A may be configured to transmit messages to and/or receive messages from the data ingestion and transformation system 102. Additionally, or alternatively, in some embodiments, the triage server 104 includes the user terminal 104D, which is communicable with the triage server 104A, and which the triage system 104 (e.g., an entity of the triage system, such as a service advisor or independent repair facility (IRF)) may use to communicate with the data ingestion and transformation system 102. (e.g., an entity of the data ingestion and transformation system 102, including domain specific endpoints, such as an API or other computer interface for the primary domain and, in non-primary domains, a domain-specific endpoint such as a customer service representative). In some such embodiments, the user terminal 104D embodies one or more user devices including a display to which information is renderable. Non-limiting examples of the user terminal 104D include a specially configured tablet device (e.g., configured to execute a particular software application or software application(s) that provide such functionality), a specially configured smartphone, and/or a specially configured mobile computer such as a laptop. In this regard, the user terminal 104D may cause provision of the physical medium by causing rendering of one or more specially configured user interfaces including a rendering of messages from the triage system and/or diagnostic resolution data or a portion thereof. For example, in some embodiments, the user terminal 104D renders an image of diagnostic resolution data (e.g., an image of an RO) for transmission to the data ingestion and transformation system 102. As illustrated, for example, the triage server 104A transmits one or more specially configured transmissions to the medium printer 104C. The medium printer 104C embodies a printer configured to print any of a variety of information on a physical medium, for example on paper and/or another printable medium. The triage server 104A may transmit the diagnostic resolution data, a portion thereof, or an associated specially configured transmission associated therewith to cause the medium printer 104C to print the diagnostic resolution data or a portion thereof on a physical medium. For example, the medium printer 104C may print a paper including the diagnostic resolution data. In this regard, the paper may be made accessible to the user terminal 104D for capturing an image of the printed paper or a portion thereof. In some non-limiting examples, the diagnostic resolution data includes vehicle related diagnostic resolution data (e.g., vehicular diagnostic resolution data) generated (e.g., via a diagnostic model) in response to one or more diagnostics run on a vehicle, such as data generated by a sensor on the vehicle and transmitted via vehicle telematics system to the triage system 104. Similarly, resolving the detected fault may include replacing one or more components of the device 114 (e.g., vehicle) and/or executing one or more software functions to modify the software of the device.

The provider system 101 is configured to perform various functionalities via the data ingestion and transformation system 102 and the adjudication system 110. For example, the data ingestion and transformation server 102A may be configured to transmit messages to and/or receive messages from the triage system 104 and/or the external system(s) 112. For example, the data ingestion and transformation server 102A may be configured to transmit API request to the triage system 102 and/or receive messages from the triage system 104 in response to the API requests. Additionally, or alternatively, in some embodiments, the data ingestion and transformation system 102 includes the provider terminal 102C, which is communicable with the data ingestion and transformation server 102, and which the provider system 101 (e.g., an entity of the provider system, such as a customer service representative) may use to communicate with the triage system 104 (e.g., an entity of the triage system 104, such as a service advisor). In some such embodiments, the provider terminal 102C embodies one or more user devices including a display to which information is renderable. Non-limiting examples of the provider terminal 102C include a specially configured tablet device (e.g., configured to execute a particular software application or software application(s) that provide such functionality), a specially configured smartphone, and/or a specially configured mobile computer such as a laptop. In this regard, the provider terminal 102C may cause rendering of one or more specially configured user interfaces including a rendering of messages from the triage system 104 and/or diagnostic resolution data or a portion thereof. For example, in some embodiments, the provider terminal 102C renders an image of diagnostic resolution data (e.g., an image of a physical medium embodying the diagnostic resolution data, such as a paper on which the diagnostic resolution data is printed or otherwise transcribed on) from the triage system 104.

In some embodiments, the data ingestion and transformation system 102 may perform one or more functionalities in response to a request from the adjudication system 110. For example, the adjudication system 110 may communicate directly or indirectly with the triage system 104 (e.g., via the triage server 104A) to facilitate a resolution of one or more device faults. Accordingly, in some examples, the adjudication system 110 may obtain one or more diagnostic identifiers from the triage system 102. In some such examples, the adjudication system 110 may transmit a request (e.g., an internal request within the provider system 101) to the data ingestion and transformation system 102 for transformation of the one or more diagnostic identifiers into one or more component and/or non-component identifiers.

The provider system 101 is configured to interact with the triage system 104 and the external service system(s) 112 over multiple domains for parallel communication, including a primary domain (e.g., an API, electronic messaging platform, or other type of software application that is configured to transmit and receive messages) and one or more secondary domains (e.g., non-primary domains, such as phone calls, mailing of paper documents, etc.). The secondary domain(s) may, in some instances, be failsafe or redundant backup communication channels configured to be used in the event of a failure or poor performance of the primary domain. In some embodiments, the provider system 101 may store user profiles associated with system users (e.g., in the data ingestion and transformation data repository), such as user profiles associated with customers and/or user profiles associated with triage systems. Additionally, in some such embodiments, the provider system 101 may update (e.g., continuously update) the user profiles, for example, based on information obtained from the triage system (or directly from the customer) before or after generation of execution instructions. Additionally, or alternatively, the provider system 101 may update the user profiles based on generated execution instructions. In some such embodiments, the provider system 101 may retrieve information from one or more user profiles (e.g., at any time and/or for any purpose). In one non-limiting example, the provider system 101 may retrieve information from a user profile to facilitate obtaining diagnostic resolution data via the primary domain. For example, the provider system may initiate a transaction with an entity of the triage system 104 via a secondary (non-primary) domain and may use information retrieved from the user profile to facilitate transmission of one or more messages (e.g., prompts, push messages) requesting submission of diagnostic resolution data via the primary domain. The secondary domain(s) may be slower and/or less accurate channels which delay data transmission and may prevent accurate analysis by the provider system, and thus, the provider system may default to directing (or redirecting) the triage system 104 to the primary domains. In another non-limiting example, the provider system may retrieve information from the user profiles for generation of execution instructions.

The data ingestion and transformation system 102 may be configured to ingest information from the triage system 104 and/or the external service system(s) 112. In some embodiments, the data ingestion and transformation system 102 may be configured to ingest diagnostic resolution data from the triage server 104A. For example, the data ingestion and transformation server 102A may be configured to use one or more API requests to obtain diagnostic resolution data from the triage server 104A. In some embodiments, the triage server 104A (e.g., an API executed via the triage server 104A) may transmit pre-generated diagnostic resolution data to the data ingestion and transformation server 102A. In some embodiments, the data ingestion and transformation server 102A may autonomously retrieve the diagnostic resolution data via one or more APIs in response to a request message (e.g., a message including a number associated with a session for generation of the diagnostic resolution data) from the triage system 104 or in response to a preconfigured trigger.

Additionally, or alternatively, the data ingestion and transformation system 102 may be configured to ingest diagnostic resolution data from the user terminal 104D. For example, user terminal 104D may be used to capture an image of a physical medium embodying the diagnostic resolution data (e.g., the repair order including diagnostic resolution data) and transmit the image to the data ingestion and transformation system 102. In some such embodiments, the data ingestion and transformation system 102 may use OCR to obtain the diagnostic resolution data from the image. In some such embodiments, the data ingestion and transformation server 102A and/or the provider terminal 102C may perform the OCR or a portion of the OCR. In some embodiments, the data ingestion and transformation server 102A may include an ORC engine, which may use one or more machine learning models to identify various diagnostic resolution data in an image. Additionally, or alternatively, the user terminal 104D may be configured to perform OCR to obtain the diagnostic resolution data. In such an example, the data ingestion and transformation server 102A may obtain the diagnostic resolution data from the user terminal 104D. In other words, the user terminal 104D may pre-OCR the image and transmit (e.g., directly or via the triage server 104A) the OCR data, which may include or be otherwise indicative of the diagnostic resolution data, to the data ingestion and transformation system 102. In some other embodiments, the customer (e.g., an owner or user of the device and/or an owner or user of the protection product for the device) may capture an image of the diagnostic resolution data and transmit the image (or OCR data of the image) to the data ingestion and transformation system 102. In some embodiments, the data ingestion and transformation system 102 may request an image (or OCR data of the image) of the diagnostic resolution data from the triage system 104 and/or the customer. The data ingestion and transformation system may be configured to receive the data in any format and extract the diagnostic identifiers therefrom, for example, by image analysis of an image data file and/or data extraction of a data (e.g., text) file.

The data ingestion and transformation system 102 is configured to transform ingested diagnostic resolution data into executable resolution data (e.g., associated with a standardized data type) for inputting into the adjudication engine. For example, the diagnostic ingestion and transformation system 102 includes a mapping engine which uses trained mapping models to map diagnostic identifiers included in the diagnostic resolution data to component and/or non-component identifiers (e.g., the executable resolution data), which are associated with the standardized data type. In some embodiments, the mapping engine uses natural language processing to map the diagnostic identifiers to the component and/or non-component identifiers. For example, the mapping engine may include a transformer neural network (e.g., a transformer model) to perform natural language processing (NLP) tasks. In some embodiments, diagnostic resolution data received by the provider system 101 may include multiple sets of diagnostic data in different data types and the mapping engine may perform one or more NPL tasks to map the multiple sets of diagnostic data to one or more component or non-component identifiers in the standardized data type. In some examples, the mapping engine may include multiple models (e.g., transformer models), in which a transformer model is used for mapping a particular data type to the standardized data type. In some such examples, the mapping engine may also include a classifier that enables the mapping engine to select a model from a plurality of models based on the diagnostic resolution data (e.g., a classifier configured to identify a data type or a closest data type for unidentified or new data types). Additionally, or alternatively, the mapping engine may include a single model configured to map multiple data types to the standardized data type. For example, a set of diagnostic resolution data may include different diagnostic identifiers having different data types. In some such examples, the mapping model may determine that the diagnostic resolution data cannot be pre-classified or is not separately identifiable as being associated with a particular data type. Accordingly, the mapping engine may use the single model to map the different diagnostic identifiers to the standardized data type. In some embodiments, a model may be trained on a large set of historical diagnostic resolution data from many device triage systems and/or a model may be trained for a particular triage system or a subset of triage systems. In some embodiments, the mapping engine may iterate through one or more models, for example, until a recognizable output is generated with a certain degree of confidence.

The provider system 101 may obtain the trained mapping model by training a mapping model using structured historical diagnostic resolution data and resolutions associated therewith. For example, the data ingestion and transformation system 102 may be configured to obtain (or otherwise generate) structured diagnostic resolution data for training one or more mapping models (e.g., machine learning models, such as transformer models). In some examples, the structured historical diagnostic resolution data may be based on (or include) diagnostic resolution data obtained from the triage system 104 and/or the external service system(s) 112.

In some embodiments, the provider system 101 may train one or more mapping models to map unstructured or structured (e.g., labeled) diagnostic resolution data. For example, the provider system 101 may obtain diagnostic resolution data that includes one or more diagnostic identifiers which are unlabeled or otherwise unstructured. Accordingly, the mapping engine may use a trained mapping model may map a diagnostic identifier (e.g., each diagnostic identifier included in unstructured diagnostic resolution data) to one or more component identifiers and/or one or more non-component identifiers. In one non-limiting example, the trained mapping model may receive unstructured diagnostic resolution data and determine that a diagnostic identifier included in the unstructured diagnostic resolution data includes a first data value (e.g., a data value configured to prevent a device fault, such as “5000-mile service”). In some examples, the trained mapping model may identify one or more components of a device that are associated with the first data value (e.g., the “oil filter”), one or more components that are not part of a device, but are otherwise associated with the first data value and/or the one or more component identifiers (e.g., “quarts of oil”), and one or more non-components that are associated with the first data value, the one or more component identifiers, and/or the one or more non-component identifiers (e.g., actions, such as “test drive”, “oil filter replacement”, and/or “tire rotation”). Additionally, or alternatively, the trained mapping model may determine that another diagnostic identifier included in the unstructured diagnostic resolution data includes a second data value, such as a data value indicative of a resolution to a device fault (“CPU reprogram”). In some examples, the trained mapping model may determine that the second data value is associated with (e.g., is only associated with) one or more non-components (e.g., an action, such as “CPU reprogram”). In other words, a trained mapping model may interpret a diagnostic identifier and identify (e.g., extract) data from the diagnostic identifier, which may be partitioned into two or more categories (i.e., “components” and “not components”). The model may be trained using labeled data from historical or hypothetical diagnostic identifiers.

In some embodiments, the two or more categories may be linked. That is, the trained mapping model may determine associations between data partitioned into a category and data partitioned into one or more other categories. In one non-limiting example, data included in a non-component category (e.g., “5000-mile service”) may be associated with data included in a first component category (e.g., “oil filter”, “tires”) and data included in a second component category (e.g., “quarts of oil”). In some examples, the data may be associated within the model via a label. That is, a same label may be applied to data included in multiple categories (e.g., a label “repair activity 1” may be applied to “5000-mile service,” “oil filter”, “tires,” and “quarts of oil”). In some embodiments, the adjudication engine may include a library (e.g., a data repository) of component and/or non-component identifiers, and the trained mapping model may be configured to match the diagnostic resolution data with the library identifiers (e.g., via classifier model such as a k-nearest neighbors algorithm).

Although examples of diagnostic identifiers, component identifiers, and non-component identifiers provided herein include terms (e.g., “5000-mile service,” “oil filter,” “CPU reprogram”), it should be appreciated that a mapping model may also be trained to map numerical codes. That is, a trained mapping model may map a diagnostic identifier that includes a numerical code to component and/or non-component identifiers that include numerical codes and/or terms. Additionally, or alternatively, a trained mapping model may map a diagnostic identifier that includes a term to component and/or non-component identifiers that include numerical codes and/or terms.

In some examples, the provider system 101 may train one or more mapping models on structured historical data associated with one or more user, one or more data types, one or more device faults, and/or various metadata. In one non-limiting examples, the provider system 101 may train one or more mapping models on one or more structured historical data sets, which enable the one or more mapping models to identify and/or predict one or more users associated with diagnostic resolution data. In another non-limiting example, the provider system 101 may train the one or more mapping models on one or more structured historical data sets (e.g., a same one or more structured historical data sets, a different one or more structured historical data sets), which enable the one or more mapping models to identify and/or predict one or more device faults associated with diagnostic resolution data. In some examples, the provider system may train the one or more mapping models to identify and predict the one or more users and/or device faults based on context information, such as metadata included in the diagnostic resolution data and/or other information pertaining to related diagnostic identifiers. In some examples, training the one or more mapping models based on context information may improve an accuracy at which the trained mapping model generates (e.g., predicts) executable resolution data.

The mapping engine includes software, which uses artificial intelligence and machine learning to interpret data and autonomously improve performance (e.g., an accuracy of data output by the software) over time, for example, without being explicitly programmed. For example, the mapping engine includes algorithms that iteratively learn patterns and insights from large datasets. In some embodiments, the software includes algorithms for data processing, model training, and inference, which may be implemented using various programming languages and data repositories. The mapping engine is executed on hardware including, but not limited to, GPUs (Graphics Processing Units) and TPUs (Tensor Processing Units).

In some embodiments, the mapping engine uses algorithms to perform natural language processing (NLP). For example, the mapping engine uses AI/ML models that analyze and understand human language and/or visual indicia, enabling tasks such as text classification, sentiment analysis, machine translation, and question answering. The mapping engine may perform NLP tasks using various techniques, including rule-based systems, statistical models, and deep learning methods like recurrent neural networks (RNNs) and transformer models such as bidirectional encoder representations from transformers (BERT). These techniques enable the mapping engine to interpret and generate human-like text.

The provider system 101 may train one or more AI/ML models through inputting labeled and/or unlabeled data. In some embodiments, the type of data input into the machine learning engine for training of a model depends on the learning task being performed by the machine learning engine. For example, in supervised learning, a model is provided with input-output pairs, such that the model may learn to map inputs to corresponding outputs by minimizing the error between its predictions and the ground truth labels. Such learning may be achieved through iterative optimization algorithms, such as gradient descent algorithms. In unsupervised learning, a model may be provided unlabeled data, within which the model identifies patterns or structures without explicit instructions. In reinforcement learning, a model is trained to generate sequences of decisions through positive reinforcement of desired outcomes and negative reinforcement for undesirable outcomes. During training, the model adjusts internal parameters or weights based on input data, gradually improving performance until a desired level of accuracy or effectiveness is obtained. The training of a reinforcement learning model may include partitioning data into training, validation, and test sets to evaluate performance and prevent overfitting, in which the model learns to memorize the training data rather than generalize to new, unseen data.

In some examples, such as for models used to perform NLP tasks, the models may be trained using textual data, such as data in the form of sentences, documents, or other textual formats. In some embodiments, training models for NLP tasks may include tokenization, in which the text is split into individual tokens, and normalization, in which the model converts tokens to base forms (e.g., lemmatization) or reducing tokens to a standard format (e.g., stemming). The converted or reduced tokens are input into the model along with corresponding labels or targets, depending on the task. For example, in sentiment analysis, each token may be labeled with a corresponding sentiment (positive, negative, neutral). Accordingly, the model learns to understand the relationships between words, phrases, and sentences in the training data, capturing semantic and syntactic structures through layers of neural networks or other learning architectures. During training, the model autonomously adjusts parameters based on the error between predictions and actual labels and improves performance through iterative modifications.

In some embodiments, the adjudication system 110 is configured to receive executable resolution data (e.g., in the standardized data type) and generate an execution instruction set. For example, the adjudication system 110 may include a preexisting adjudication engine (e.g., a legacy adjudication system) configured to adjudicate data in the standardized data type. Accordingly, the data ingestion and transformation system 102 (e.g., the mapping engine executed via the data ingestion and transformation server 102A) may retrofit the preexisting adjudication engine to receive (and adjudicate on) the diagnostic resolution data associated with different data types (e.g., in the form of executable resolution data) without modifying the preexisting adjudication engine. In other words, the mapping engine enables the preexisting adjudication engine to provide adjudication functionality for data types other than the standardized data type.

In some embodiments, the adjudication system 110 (e.g., the adjudication engine executed via the adjudication server 110A, in some instances in conjunction with the adjudication repository 110B) is configured to adjudicate in accordance with an adjudication framework. The adjudication framework includes a rule set for generating execution instructions based on executable resolution data. In some embodiments the adjudication system may identify a customer associated with executable resolution data. For example, the executable resolution data may be indicative of the customer and/or the data ingestion and transformation system 102 may transmit an indication of the customer to the adjudication system 110 (e.g., with the executable resolution data). In some such embodiments, the adjudication system 110 may generate the execution instruction set (e.g., may adjudicate on the executable resolution data) by comparing user profile data (e.g., including protection product information) corresponding to the identified customer with component and/or non-component identifiers included the executable resolution data.

The provider system 102 may be configured to transmit an execution instructions set generated by the adjudication system 110 to the triage system 104 (or directly to the customer or to an external service system 112). For example, the adjudication system 110 (or the data ingestion and transformation system 102) may transmit a message including or otherwise indicative of the execution instruction set to the triage system 102 and/or customer authorizing or rejecting a resolution for one or more device faults and/or instructing one or more repairs on the device 114. Additionally, or alternatively, the adjudication system 110 (or the data ingestion and transformation system 102) may transmit computer instructions configured to cause the resolution to be executed (or prevent the resolution from being executed).

Diagnostic resolution data may include diagnostic identifiers corresponding to one or more non-component identifiers, one or more component identifiers, or a combination of one or more non-component and one or more component identifiers. In some embodiments, executable resolution data may include one or more non-component identifiers, one or more component identifiers, or a combination of one or more non-component identifiers and one or more component identifiers. In some examples, such as examples in which executable resolution data includes a combination of one or more non-component identifiers and one or more component identifiers, the adjudication system 110 (e.g., the adjudication engine within the adjudication system) may compare the one or more component identifiers to the one or more non-components to determine whether the one or more non-component identifiers are compatible with the one or more component identifiers. In some examples, the adjudication engine may determine that the one or more non-component identifiers are incompatible with the one or more component identifiers. In some such examples, the adjudication engine may refrain from adjudicating on the executable resolution data. Additionally, or alternatively, the adjudication system 110 may transmit feedback to the data ingestion and transformation system 102. The feedback may include, for example, an indication of the incompatibility and/or a request for the data ingestion and transformation system 102 to regenerate the executable resolution data (e.g., update the executable resolution date, generate a second set of executable resolution data).

Although the foregoing description of FIG. 1, and the associated drawing, describes example embodiments in the context of certain example combinations of systems, apparatuses, and/or functions, it should be appreciated that different combinations of systems, apparatuses, and/or functions may be provided by alternative embodiments without departing from the scope of the appended claims. In this regard, for example, different combinations of systems, apparatuses, and/or functions than those explicitly described above are also contemplated as may be set forth in some of the appended claims.

### Example Apparatuses of the Disclosure

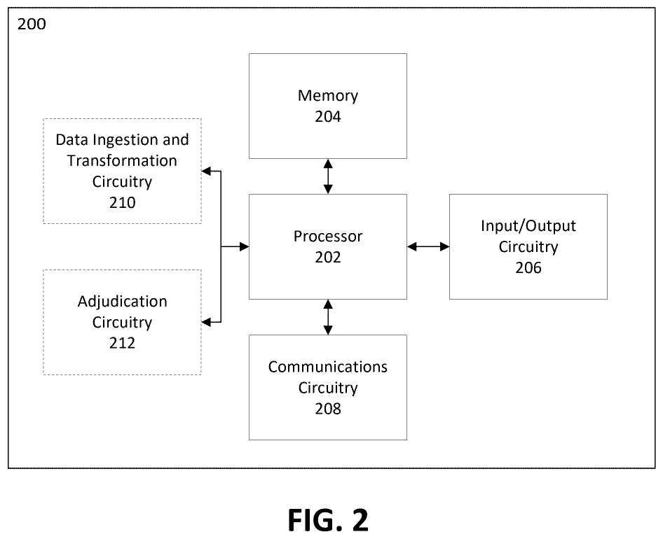

Having discussed example systems in accordance with the present disclosure, example apparatuses in accordance with the present disclosure will now be described. The apparatus 200 includes a processor 202, a memory 204, an input/output circuitry 206, and a communications circuitry 208. In some embodiments, the provider system 101 as described herein with respect to FIG. 1 is embodied by one or more computing systems. For example, in at least one embodiment, the data ingestion and transformation system 102 is embodied by the apparatus 200 as depicted and described in FIG. 2. For example, in addition to the processor 202, the memory 204, the input/output circuitry 206, and the communications circuitry 208, the apparatus 200 may include data ingestion and transformation circuitry 210. In such an example, the apparatus 200 may use one or more of the sets of circuitry 202, 204, 206, 208, 210, and/or 212 to execute any one or more of the operations described herein, such as one or more operations described with respect to FIG. 1 as being performed by the data ingestion and transformation system 102.

In at least one other embodiment, the adjudication system 110 is embodied by the apparatus 200 as depicted and described in FIG. 2. For example, in addition to the processor 202, the memory 204, the input/output circuitry 206, and the communications circuitry 208, the apparatus 200 may include adjudication circuitry 212. In such an example, the apparatus 200 may use one or more of the sets of circuitry 202, 204, 206, 208, 210, and/or 212 to execute any one or more of the operations described herein, such as one or more operations described with respect to FIG. 1 as being performed by the adjudication system 102.

In at least one other embodiment, the triage system 104 is embodied by the apparatus 200 as depicted and described in FIG. 2. For example, the apparatus 200 may use one or more of the sets of circuitry 202, 204, 206, and/or 208 to execute any one or more of the operations described herein, such as one or more operations described with respect to FIG. 1 as being performed by the triage system 104.

In at least one other embodiment, the external service system(s) 112 are embodied by the apparatus 200 as depicted and described in FIG. 2. For example, the apparatus 200 may use one or more of the sets of circuitry 202, 204, 206, and/or 208 to execute any one or more of the operations described herein, such as one or more operations described with respect to FIG. 1 as being performed by the external service system(s) 112.

In at least one embodiment, the device 114 as depicted and described herein with respect to FIG. 1 is embodied by one or more computing systems. In an example embodiment, the device 114 is embodied by the apparatus 200 as depicted and described in FIG. 2. For example, the apparatus 200 may use one or more of the sets of circuitry 202, 204, 206, and/or 208 to execute any one or more of the operations described herein, such as one or more operations described with respect to FIG. 1 as being performed by the device 114.

Although components are described with respect to functional limitations, it should be understood that the particular implementations necessarily include the user of particular computing hardware. It should also be understood that certain of the components described herein may include similar or common hardware. For example, two sets of circuitry for example, may both leverage use of the same processor(s), network interface(s), storage medium(s), and/or the like, to perform their associated functions, such that duplicate hardware is not required for each set of circuitry. The user of the term “circuitry” as used herein with respect to components of the apparatuses described herein should therefore be understood to include particular hardware configured to perform the functions associated with the particular circuitry as described herein.

Particularly, the term “circuitry” should be understood broadly to include hardware and, in some embodiments, software for configuring the hardware. For example, in some embodiments, “circuitry” includes processing circuitry, storage media, network interfaces, input/output devices, and/or the like. Alternatively or additionally, in some embodiments, other elements of the apparatus 200 may provide or supplement the functionality of another particular set of circuitry. For example, the processor 202 in some embodiments provides processing functionality to any of the sets of circuitry, the memory 204 provides storage functionality to any of the sets of circuitry, the communications circuitry 208 provides network interface functionality to any of the sets of circuitry, and/or the like.

In some embodiments, the processor 202 (and/or co-processor or any other processing circuitry assisting or otherwise associated with the processor) may be in communication with the memory 204 via a bus for passing information among components of the apparatus 200. In some embodiments, for example, the memory 204 is non-transitory and may include, for example, one or more volatile and/or non-volatile memories. In other words, for example, the memory 204 in some embodiments includes or embodies an electronic storage device (e.g., a computer readable storage medium). In some embodiments, the memory 204 is configured to store information, data, content, applications, instructions, or the like, for enabling the apparatus 200 to carry out various functions in accordance with example embodiments of the present disclosure.

The processor 202 may be embodied in a number of different ways. For example, in some example embodiments, the processor 202 includes one or more processing devices configured to perform independently. Additionally, or alternatively, in some embodiments, the processor 202 includes one or more processor(s) configured in tandem via a bus to enable independent execution of instructions, pipelining, and/or multithreading. The use of the terms “processor” and “processing circuitry” may be understood to include a single core processor, a multi-core processor, multiple processors internal to the apparatus 200, and/or one or more remote or “cloud” processor(s) external to the apparatus 200.

In an example embodiment, the processor 202 may be configured to execute instructions stored in the memory 204 or otherwise accessible to the processor. Alternatively or additionally, the processor 202 in some embodiments is configured to execute hard-coded functionality. As such, whether configured by hardware or software methods, or by a combination thereof, the processor 202 may represent an entity (e.g., physically embodied in circuitry) capable of performing operations according to an embodiment of the present disclosure while configured accordingly. Alternatively or additionally, as another example in some example embodiments, when the processor 202 is embodied as an executor of software instructions, the instructions may specifically configure the processor 202 to perform the algorithms embodied by the specific operations described herein when the instructions are executed.

As one particular example, the processor 202 may be configured to perform various operations embodying automatic transformation of diagnostic resolution data. In this regard, the processor 202 in some embodiments is configured to perform and/or otherwise support the various functionality performed by the provider system 101, as described herein. In some embodiments, the processor 202 includes hardware, software, firmware, and/or a combination thereof, that maintains diagnostic resolution data comprising one or more first diagnostic identifiers associated with one or more device faults. In some such embodiments, the processor 202 includes hardware, software, firmware, and/or a combination thereof, that transforms, via a mapping engine comprising a trained mapping model, the diagnostic resolution data into executable resolution data by mapping the one or more first diagnostic identifiers to at least one or more component identifiers. Additionally, or alternatively, in some embodiments, the processor 202 includes hardware, software, firmware, and/or a combination thereof, that generates an execution instruction set, via an adjudication engine comprising an adjudication framework, based on the one or more component identifiers. Additionally, or alternatively, in some embodiments, the processor 202 includes hardware, software, firmware, and/or a combination thereof, that maintains the execution instruction set to facilitate a resolution for the one or more device faults.

In some embodiments, the processor 202 includes hardware, software, firmware, and/or a combination thereof, that maintains an image comprising the one or more first diagnostic identifiers. Additionally, or alternatively, in some embodiments, the processor 202 includes hardware, software, firmware, and/or a combination thereof, that generates the diagnostic resolution data from the image using optical character recognition.

Additionally, or alternatively, in some embodiments, the processor 202 includes hardware, software, firmware, and/or a combination thereof, maintains information to facilitate an application programming interface request to an endpoint of a first computing system associated with generating the one or more first diagnostic identifiers. Additionally, or alternatively, in some embodiments, the processor 202 includes hardware, software, firmware, and/or a combination thereof, that maintains diagnostic resolution data in response to the application programming interface request to the endpoint of the first computing system.

Additionally, or alternatively, in some embodiments, the processor 202 includes hardware, software, firmware, and/or a combination thereof, that maintains a diagnostic session identifier associated with the one or more first diagnostic identifiers, wherein the application programming interface request comprises at least the diagnostic session identifier.

Additionally, or alternatively, in some embodiments, the processor 202 includes hardware, software, firmware, and/or a combination thereof, that maintains system user information (e.g., user profile information), such has an indication of a diagnostic session identifier or an image associated with a diagnostic session associated with the one or more device faults. Additionally, or alternatively, in some embodiments, the processor 202 includes hardware, software, firmware, and/or a combination thereof, that automatically triggers receipt of the diagnostic resolution data in response to receipt of the indication.

Additionally, or alternatively, in some embodiments, the processor 202 includes hardware, software, firmware, and/or a combination thereof, that obtains, via a secondary domain, a request to initiate a transaction from a system user associated with a device experiencing the one or more device faults. Additionally, or alternatively, in some embodiments, the processor 202 includes hardware, software, firmware, and/or a combination thereof, that automatically triggers transmission of one or more electronic messages to the system user via a first domain or the secondary domain, wherein the one or more electronic messages comprise instructions pertaining to initiation of a transaction, and wherein reception of the diagnostic resolution data is based at least in part on transmission of the one or more electronic messages. In some such examples, at least one electronic message of the one or more electronic messages comprises a deep link transmitted to a computing device associated with the system user, the computing device being different than the device experiencing the one or more device faults.

Additionally, or alternatively, in some embodiments, the processor 202 includes hardware, software, firmware, and/or a combination thereof, that triggers transmission of status information to the system user via the secondary domain, wherein the status information pertains to a status of a transaction.

Additionally, or alternatively, in some embodiments, the processor 202 includes hardware, software, firmware, and/or a combination thereof, that outputs a request to a system user associated with a device experiencing the one or more device faults based at least in part on a failure to map at least one diagnostic identifier of the one or more first diagnostic identifiers to a respective component identifier. Additionally, or alternatively, in some embodiments, the processor 202 includes hardware, software, firmware, and/or a combination thereof, that obtains a second diagnostic identifier from the system user, the second diagnostic identifier being mappable onto the respective component identifier. Additionally, or alternatively, in some embodiments, the processor 202 includes hardware, software, firmware, and/or a combination thereof, that substitutes at least one diagnostic identifier with a second diagnostic identifier in diagnostic resolution data.

Additionally, or alternatively, in some embodiments, the processor 202 includes hardware, software, firmware, and/or a combination thereof, that identifies a system user that corresponds to a device associated with the one or more device faults based at least in part on a comparison of user profile data with at least one component identifier of the one or more component identifiers, wherein the execution instruction set is based at least in part on the system user.

Additionally, or alternatively, in some embodiments, the processor 202 includes hardware, software, firmware, and/or a combination thereof, that trains mapping model using structured historical diagnostic resolution data comprising a plurality of historical diagnostic identifiers, and historical executable resolution data comprising a plurality of component identifiers associated with the structured historical diagnostic resolution data to obtain the trained mapping model. In some such embodiments, the trained mapping model comprises at least one natural language processing model, and wherein transformation of the diagnostic resolution data into the executable resolution data is based at least in part on applying the diagnostic resolution data to the at least one natural language processing model using the mapping engine.

In some embodiments, the processor 202 performs one or more actions in combination with another set of circuitry of the apparatus 200.

The input/output circuitry 206 provides output to the user and, in some embodiments, receives one or more indication(s) of user input. In some embodiments, the input/output circuitry 206 is in communication with processor 202 to provide such functionality. The input/output circuitry 206 includes one or more user interface(s) and/or includes a display that may comprise the user interface(s) rendered as a web user interface, an application interface, and/or the like, to the display of a user device, a back-end system, or the like. In some embodiments, the input/output circuitry 206 may also include a keyboard, a mouse, a joystick, a touch screen, touch areas, soft keys, a microphone, a speaker, or other input/output mechanisms. The processor 202 and/or input/output circuitry 206 comprising or otherwise interacting with the processor 202 may be configured to control one or more functions of one or more user interface elements through computer program instructions (e.g., software and/or firmware) stored on a memory accessible to the processor 202 (e.g., stored on memory 204, and/or the like).

The communications circuitry 208 includes any device, circuitry, and/or other means embodied in hardware, software, firmware, and/or a combination of hardware, software, and software that is configured to receive and/or transmit data from/to a network and/or any other device, circuitry, or module of or in communication with the apparatus 200. In this regard, the communications circuitry 208 may include, for example, a network interface for enabling communications with a wired or wireless communication network. For example, the communications circuitry 208 in some embodiments includes one or more network interface card(s), antenna(s), bus(es), switch(es), router(s), modem(s), and supporting hardware and/or software, or any other device suitable for enabling communications via one or more communication network(s). Additionally, or alternatively, in some embodiments the communications circuitry 208 includes circuitry for interacting with the antenna(s) and/or other hardware or software to cause transmission of signals via the antenna(s) or to handle receipt of signals received via the antenna(s).

The data ingestion and transformation circuitry 210 includes hardware, software, firmware, and/or a combination thereof, configured to support various aspects of automatic transformation of diagnostic resolution data as described herein. In some embodiments, the data ingestion and transformation circuitry 210 utilizes processing circuitry, such as the processor 202 and/or the like, to perform one or more of such actions. Additionally, or alternatively, in some embodiments, the data ingestion and transformation circuitry 210 utilizes input/output circuitry 206 to facilitate user output (e.g., causing rendering of one or more user interface(s)), and/or to receive user input (e.g., user clicks, user taps, keyboard interactions, user gesture, and/or the like). Additionally, or alternatively still, in some embodiments, the data ingestion and transformation circuitry 210 utilizes communications circuitry 208 to initiate transmissions to another computing device, receive transmissions from another computing device, communicate signals between the various sets of circuitry as depicted, and/or the like. For example, in some embodiments, the data ingestion and transformation circuitry 210 includes hardware, software, firmware, and/or a combination thereof, that transforms, via a mapping engine comprising a trained mapping model, diagnostic resolution data into executable resolution data by mapping one or more first diagnostic identifiers to at least one or more component identifiers. It should be appreciated that, in some embodiments, the data ingestion and transformation circuitry 210 may include a separate processor, specially configured field programmable gate array (FPGA), or a specially programmed application specific integrated circuit (ASIC), to perform such functionality.

The adjudication circuitry 212 includes hardware, software, firmware, and/or a combination thereof, configured to support various aspects of automatic transformation of diagnostic resolution data as described herein. In some embodiments, the adjudication circuitry 212 utilizes processing circuitry, such as the processor 202 and/or the like, to perform one or more of such actions. Additionally, or alternatively, in some embodiments, the adjudication circuitry utilizes input/output circuitry 206 to facilitate user output (e.g., causing rendering of one or more user interface(s)), and/or to receive user input (e.g., user clicks, user taps, keyboard interactions, user gesture, and/or the like). Additionally, or alternatively still, in some embodiments, the adjudication circuitry 212 utilizes communications circuitry 208 to initiate transmissions to another computing device, receive transmissions from another computing device, communicate signals between the various sets of circuitry as depicted, and/or the like. For example, in some embodiments, the adjudication circuitry 212 includes hardware, software, firmware, and/or a combination thereof, that generates an execution instruction set, via an adjudication engine comprising an adjudication framework, based on the one or more component identifiers. It should be appreciated that, in some embodiments, the adjudication circuitry 212 may include a separate processor, specially configured field programmable gate array (FPGA), or a specially programmed application specific integrated circuit (ASIC), to perform such functionality.

It should be appreciated that, in some embodiments, one or more of the sets of circuitry 202-212 are combinable. Alternatively or additionally, in some embodiments, one or more of the sets of circuitry performs some or all of the functionality described associated with another set of circuitry. For example, in some embodiments, the data ingestion and transformation circuitry 210 and/or the adjudication circuitry 212 is combined with the processor 202, such that the processor 202 performs one or more of the operations described above with respect to the data ingestion and transformation circuitry 210 and/or adjudication circuitry 212. It should also be appreciated that the circuitry depicted in FIG. 2 illustrates one example embodiment and the functionality described herein may be implemented by other combinations of hardware, software, firmware, and/or the like.

### Example Computing Environments of the Disclosure

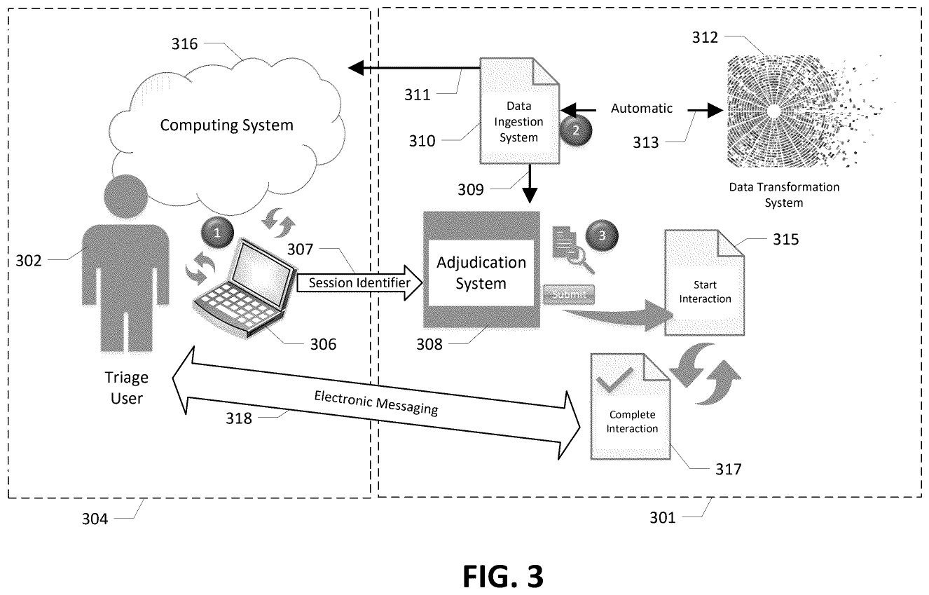

FIG. 3 illustrates visualizations of example computing environments specially configured to facilitate automatic transformation of diagnostic resolution data in accordance with at least some example embodiments of the present disclosure. Specifically, as illustrated, the example computing environment includes a provider system environment 301 and a triage system environment 304. The provider system 101 described with respect to FIG. 1, may be embodied in the provider system environment 301. Additionally, or alternatively, the triage system 104 described with respect to FIG. 1, may be embodied in the triage system environment 304. Each of the depicted environments are maintained via hardware, software, and/or firmware. In this regard, each of the depicted environments includes any number of software process(es) that interact to provide the functionality described. Each software process maintains any number of data objects utilized to provide functionality performed by each of the software processes and/or another software process. It should be appreciated that the software process(es) may be entirely distinct (e.g., executed utilizing different computing hardware and/or in different runtime environments), integrated and/or otherwise utilizing one or more shared functionality, and/or the like. In some embodiments, the provider system environment 301 supports API retrieval of diagnostic resolution data, for example, after receiving a session identifier associated with the diagnostic resolution data. While the embodiment shown and described with respect to FIG. 3 shows at least some example embodiments of the present disclosure, it should be appreciated that various other embodiments disclosed herein may be interchanged, in whole or in part, with the embodiment of FIG. 3, or portions thereof, without departing from the scope of the present disclosure.

As depicted, the triage system environment 304 includes a triage user 302. The triage user 302 may be a system user of the provider system environment 301. For example, the triage user 302 may have a user profile with the provider system and may use a user terminal 306 to access the user profile and/or other functionalities of the provider system environment 301, for example, via an adjudication system 308 of the provider system environment 301.

As depicted, the triage user 302 (e.g., a service advisor) may use a computing system 316 (e.g., a triage management system) to maintain diagnostic resolution data generated by the triage user 302, for example, based on one or more diagnostic measurements associated with a device. The diagnostic resolution data may include one or more diagnostic identifiers associated with one or more faults in the device (e.g., one or more device faults). The device may be associated with a protection product provided by the provider system environment 301.

As depicted, at step 1, the triage user 302 may transmit information pertaining to the diagnostic resolution data, including a session identifier 307, to the provider system environment 301 via the adjudication system 308. In response to receiving the session identifier 307 (e.g., and/or other data, such as an identifier associated with the computing system), the provider system environment 301 may use the session identifier 307 to retrieve the diagnostic resolution data. For example, one or more back-end components of the adjudication system 308 may include a data ingestion system 310 and a data transformation system 312, which communicate via a communication link 313. Although illustrated as separate components, in some embodiments, the data ingestion system 310 and the data transformation system 312 may be incorporated in the provider system environment 301 as a single system, such as a data ingestion and transformation system 102 illustrated by and described with reference to FIG. 1.

As depicted, at step 2, the data ingestion system 310 (e.g., via communication from the adjudication system 308 or directly from the triage system environment 304) may obtain the session identifier 317 from the adjudication system 308 via a communication link 309 and then may obtain the diagnostic resolution information from the computing system 316 via a communication link 311. In some embodiments, the data ingestion system 310 may obtain the diagnostic resolution information by transmitting an API request to an endpoint of the computing system 316. In such an example, the API request includes the session identifier 307. In some examples, the data ingestion system 310 transmits the API request based on the triage user 302 authorizing (e.g., pre-authorizing) the provider system environment 301 to access information in the computing system 316 that is associated with the triage user 302. Additionally, the data transformation system 312 may automatically transform the diagnostic resolution data into executable resolution data by mapping the one or more diagnostic identifiers to one or more component and/or non-component identifiers. For example, the data transformation system 312 may include a mapping engine configured to use one or more trained mapping models to map diagnostic identifiers with different data types to one or more component or non-component identifiers with a standardized data type, as described with respect to the various embodiments herein. The data ingestion system 310 may pass (e.g., transmit) the executable resolution data to the adjudication system 308. For example, the adjudication system 308 may include (or be communicable with) an adjudication system, such as an adjudication system 110 illustrated by and described with reference to FIG. 1.

Accordingly, as depicted at step 3, the adjudication system 308 (e.g., the adjudication system within the system user portal) may generate an execution instruction set based on the one or more component identifiers and/or one or more non-component identifiers. For example, the adjudication system may include set an adjudication engine configured to adjudicate on the executable resolution data in accordance with an adjudication framework. In some embodiments, the adjudication system 308 may generate the execution instructions based on an electronic message (e.g., an acknowledgement message) from the triage user 302. For example, the adjudication system 308 may provide the executable resolution data and one or more associated confidence levels to the triage user 302. In some examples, the service advisor may determine, based on the one or more confidence levels, to transmit an acknowledgement message to adjudication system 308 indicating an acceptance of the executable resolution data. In such examples, the adjudication system 308 may adjudicate (e.g., auto-adjudicate) on the executable resolution instructions based on the acknowledgement message.

Additionally, or alternatively, the provider system environment 301 may use one or more confidence levels output by the data transformation system 312 to determine whether to transmit the execution instructions. For example, the data transformation system 312 may generate the executable resolution data (e.g., may automatically transform the diagnostic resolution data into executable resolution data by mapping the one or more diagnostic identifiers to one or more component and/or non-component identifiers) and one or more confidence level values associated therewith (e.g., a respective confidence level associated with each component and/or non-component identifier). Accordingly, the data transformation system 312 may transmit the executable resolution data and the one or more confidence levels to the system user portal (e.g., via the data ingestion system 310) for adjudication. In some examples, the system user portal 301 may determine that the one or more confidence levels (e.g., all or a portion of the one or more confidence levels) fail to satisfy a threshold. In some such examples, the provider system 301 may refrain from transmitting the execution instructions to the triage user 302. Additionally, or alternatively, the provider system 301 may determine to obtain additional diagnostic resolution data (e.g., may determine that a portion of diagnostic resolution information is missing). In some examples, the provider system 301 may autonomously obtain the additional diagnostic resolution data. In some other examples, the provider system 301 may transmit a request for the additional diagnostic resolution data, for example, to the triage user 302. In some embodiments, the triage user 302 may interact with the adjudication system 308 (e.g., the adjudication engine within the adjudication system 308). For example, at 315, an interaction with the adjudication engine may start. In some examples, the interaction with the adjudication engine may start as a secondary domain communication (e.g., with a provider user, such as a customer service representative) in response to a failure of the primary domain or misdirection by the triage system. In some examples, during the interaction, the adjudication system 308 may trigger the adjudication engine to transmit a request to the triage user 302 based on a failure to map one or more of the diagnostic identifiers to a respective component and/or non-component identifier. Additionally, or alternatively, the adjudication system 308 may trigger the adjudication engine to transmit the request based on a confidence level failing to satisfy a threshold. Additionally, or alternatively, in some embodiments, the triage user 302 may initiate the interaction with the adjudication engine, for example, based on the executable resolution data. For example, the triage user 302 may initiate the interaction to, for example, request a modification to the executable resolution data. In some examples, communications between the triage user 302 and the provider system environment 301 via the adjudication system 308 may correspond to communication via a first (e.g., primary domain). In some embodiments, the secondary domain may include a failsafe customer service representative.

In some embodiments, the provider system environment 301 may process the obtained diagnostic resolution data irrespective of a lack of data and/or a failure to map one or more diagnostic identifiers to corresponding component and/or non-component identifiers. For example, the provider system environment 301 may fail to determine a device (e.g., vehicle) and/or customer associated with the device based on diagnostic resolution data received from the triage system environment 304. In some embodiments, the provider system environment 301 may initiate a dummy session for the diagnostic resolution data, and then may associate (e.g., convert, merge, copy, link) the dummy session with a user profile corresponding to the customer after the customer is determined. Additionally, or alternatively, the provider system environment 301 may determine that the diagnostic resolution data is incomplete (e.g., that one or more portions of the diagnostic resolution data is missing and/or un-mappable). In some examples, concurrent with processing completed portions of the diagnostic resolution data (e.g., mapping of the non-missing and/or decipherable portions of data), the provider system environment 301 may perform one or more operations to obtain the missing and/or indecipherable (missing/indecipherable) portions of the diagnostic resolution data. For example, the provider system environment 301 may request the data from the triage user 302 and/or customer (e.g., via a primary domain or a secondary domain). Additionally, or alternatively, the provider system environment 30 may retrieve the missing portions of data from a user profile associated with the triage user 302 and/or a user profile associated with the customer (e.g., data associated with a customer may be linked to data received from the triage system environment). The provider system may maintain a record associated with the particular session, device, fault, or at least one other available identifier which may be supplemented in parallel or asynchronously as data is received. In some embodiments, the provider system may query an internal database for open cases when receiving new inbound diagnostic resolution data. Irrespective of a level of completeness associated with diagnostic resolution data received from the triage user 302, the provider system environment 301 may initiate processing of the diagnostic resolution data, thereby reducing delays associated with resolving device faults. Moreover, the provider system environment 301 may provide for confidence level scaling in which a system user (e.g., the triage user 302, the customer) may request a level of confidence to be achieved by the provider system environment 301 for executable resolution data on which the provider system environment 301 may adjudicate. In one non-limiting example, a system user may select a relative low confidence level which may be more error prone and the provider system environment 301 may be configured to perform autonomous adjustments to the diagnostic resolution data and/or executable resolution data based on missing/indecipherable diagnostic resolution data via additional electronic messaging 318, defaulting to the primary domain with one or more secondary domains as a failsafe. In some examples, a failsafe may include an interaction between the triage user 302 and a provider user via one or more secondary domains (e.g., a telephone call). Alternatively, the system user may select a relatively high confidence level in which the provider system environment 301 may request manual entry and/or adjustment of the executable resolution data and/or the missing/indecipherable diagnostic resolution data.

At 318, during the interaction between the triage user 302 and the adjudication engine, the triage user 302 may transmit an acknowledgement message (e.g., an approval email) to the provider system environment 301 (e.g., via the system user portal or another domain) indicating an acceptance of the executable resolution data (or a modified version of the executable resolution data). Accordingly, at 317, the provider system environment 301 (e.g., the adjudication engine) may complete the interaction with the triage user 302 based on the acknowledgement message. In some embodiments, in response to completing the interaction and/or in response to the adjudication, the provider system environment 301 may transmit the execution instruction set to the triage user 302, for example, to facilitate a resolution for the one or more device faults.

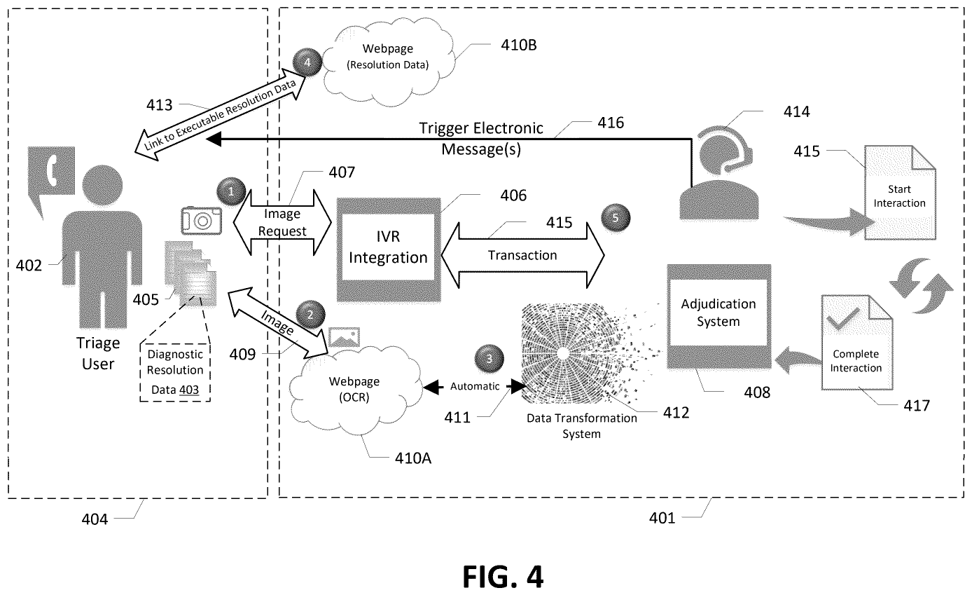

FIG. 4 illustrates visualizations of example computing environments specially configured to facilitate automatic transformation of diagnostic resolution data in accordance with at least some example embodiments of the present disclosure. Specifically, as illustrated, the example computing environment includes a provider system environment 401 and a triage system environment 404. The provider system environment 401 may be an example of the provider system environment 301 illustrated by and describe with reference to FIG. 3. For example, the provider system 101 described with respect to FIG. 1, may be embodied in the provider system environment 401. Additionally, or alternatively, the triage system environment 404 may be an example of the triage system environment 304 illustrated by and described with reference to FIG. 3. For example, the triage system 104 described with respect to FIG. 1, may be embodied in the triage system environment 404. Each of the depicted environments are maintained via hardware, software, and/or firmware. In this regard, each of the depicted environments includes any number of software process(es) that interact to provide the functionality described. Each software process maintains any number of data objects utilized to provide functionality performed by each of the software processes and/or another software process. It should be appreciated that the software process(es) may be entirely distinct (e.g., executed utilizing different computing hardware and/or in different runtime environments), integrated and/or otherwise utilizing one or more shared functionality, and/or the like. The provider system environment 401 may support retrieval of diagnostic resolution data via picture OCR (e.g., cell phone capture of the diagnostic resolution data). While the embodiment shown and described with respect to FIG. 4 shows at least some example embodiments of the present disclosure, it should be appreciated that various other embodiments disclosed herein may be interchanged, in whole or in part, with the embodiment of FIG. 4, or portions thereof, without departing from the scope of the present disclosure.

For example, in some embodiments, the provider system environment 401 supports input channel diversion in which a transaction with a system user may be initiated via a secondary domain (e.g., phone call) and the provider system environment 401 may trigger electronic messages to the system user in either a primary domain (e.g., text/email, such as with a deep link) or a secondary domain (e.g., voice command, or other messaging system) configured to transition the user to the primary domain either in parallel with the existing secondary domain communication or as a replacement for the existing secondary domain communication. In some such embodiments, the electronic messages may direct the system user to submit diagnostic resolution data (e.g., include a deep link for submission of the diagnostic resolution data) via the primary domain, such as by API or other electronic file transfer. Additionally, during the transaction, the provider system environment 401 may process the diagnostic resolution data and may generate executable resolution data (e.g., for approval and adjudication) or output status information to the system user. The status information may include, for example, a status associated with generation of the execution instructions set (e.g., an estimated time associated with transmission of the execution instructions set to the system user), executable resolution data, and/or requests for additional information (which may implicitly indicate a pending status).

For example, a system user, such as a triage user 402, may transmit a request to the provider system environment 401, in which the request is to initiate a transaction with the provider system environment 401, such as, in some embodiments, via a provider user 414 or other secondary domain. For example, the triage user 402 (e.g., a user, such as an employee of an independent repair facility (IRF) or dealer) may be a system user associated with a device experiencing the one or more device faults and may request the transaction, such that the triage user 402 may obtain execution instructions to facilitate a resolution for the one or more device faults. The execution instructions are based on diagnostic resolution data. Accordingly, the triage user 402 (e.g., a service advisor, an IRF) may request to initiate an interaction with the provider user 414, such that the triage user 402 may provide the provider user 414 diagnostic resolution data 403 associated with the one or more device faults (e.g., for generation of the execution instructions). For example, the diagnostic resolution data 403 may include one or more diagnostic identifiers associated with the one or more device faults.

As depicted, the provider system environment 401 includes an interactive voice response (IVR) integration 406, which may engage the user instead of or in addition to the provider user 414 (e.g., a customer service representative). In some embodiments, the provider system may be configured to redirect the triage user 402 to a primary domain (e.g., steps 2-3 shown in FIG. 4) regardless of the triage user's means of initial communication with the provider system. In some embodiments, in response to the request to initiate the transaction, the IVR integration 406 may initiate a session with the triage user 402 (e.g., via the secondary domain). In some such embodiments, the IVR integration 406 is a visual IVR integration in which the IVR integration 406 is configured to interrupt the IVR session by, for example, transmitting one or more electronic messages to the triage user 402 via a primary domain (e.g., via a text message or email) or a secondary domain (e.g., via a voice command over the telephone). That is, responsive to the request, the IVR integration 406 may initiate a session and, during the session, may trigger transmission of one or more electronic messages 416 to the triage user 402 via the primary domain or the secondary domain.

As depicted in step 1, the one or more electronic messages include instructions pertaining to initiation of the transaction. For example, an electronic message of the one or more electronic messages may include a deep link or other electronic prompt comprising an image request 407 for the triage user 402 to transmit an image of diagnostic resolution data, such that the provider system environment 401 may initiate the transaction. The image may include a PDF, JPEG, or other document capable of autonomous visual and/or textual interpretation by the data transformation system. In some embodiments, the triage user 402 may generate or otherwise transfer the diagnostic resolution data 403 to a physical medium 405 (e.g., a paper copy of the diagnostic resolution data 403 or a rendering of the diagnostic resolution data 403 on a device, such as a desktop computer), such that the triage user 402 may capture the image 409 of the physical medium 405.

In some embodiments, the electronic message (or another electronic message) also includes a link (e.g., a deep link) to a webpage 410A associated with the provider system environment 401. In some such embodiments, triage user 402 may click the link and perform one or more actions, such as inputting one or more credentials to login to the webpage 410A. In response to logging into the webpage 410A, the IVR integration 406 may transmit another electronic message including instructions for the triage user 402 to submit (e.g., upload) the image 409 to the webpage 410A. In some other embodiments, an electronic message may include instructions to email the image 409 to an email address associated with the provider system environment 401. In some other embodiments, the IRF may input a session identifier or other electronic information in addition to or instead of the image, similar to the process shown and described with respect to FIG. 3.

In some embodiments, as depicted at step 2, the triage user 402 may upload the image 409 to the webpage 410A. In response to obtaining the image, the provider system environment 401 may translate the image into text or other programmatically readable form (e.g., using OCR to obtain OCR data) of the diagnostic resolution data (e.g., all or a portion of the diagnostic identifiers included in the diagnostic resolution data 403) from the image 409. In some embodiments, the webpage 410A may embody at least part of a data ingestion system, such as is described with reference to FIG. 3.

As depicted at step 3, a data transformation system 412 may be communicable with the webpage 410A via a communication link 411. Accordingly, the data transformation system 412 may automatically transform the OCR data into executable resolution data by mapping the one or more diagnostic identifiers (or the portion obtained from the image 409) to one or more component and/or non-component identifiers. For example, the data transformation system 412 may include a mapping engine configured to use one or more trained mapping models to map diagnostic identifiers with different data types to one or more component or non-component identifiers with a standardized data type in accordance with any of the various embodiments disclosed herein. Although illustrated as separate components, in some embodiments, the webpage 410A and the data transformation system 412 may be incorporated in the provider system environment 401 as a single system. For example, the data transformation system 412 may correspond to a back-end component of the webpage 410A.

In some embodiments, the provider system environment 401 may generate executable resolution data and output the executable resolution data to the triage user 402 (e.g., for review and approval). For example, an electronic message of the one or more electronic messages (e.g., sent via a primary domain, such as in the form of an email) includes a second link 413 to a webpage 410B. For example, in some embodiments, the webpage 410A (or one or more back-end components) may be communicable with the webpage 410B and/or with the adjudication system 408, such that the webpage 410A may transmit (e.g., pass) the executable resolution data to the webpage 410B (e.g., directly or via the adjudication system 408).

As depicted in step 4, the triage user 402 may click the second link to obtain (e.g., view) the executable resolution data via the webpage 410B. In some embodiments, the triage user 402 may transmit an acknowledgement message accepting (e.g., approving, submitting) the executable resolution data. For example, the triage user 402 may determine, based on the executable resolution data, to transmit an acknowledgement message to adjudication system 308 indicating an acceptance of the executable resolution data. In such examples, the adjudication system 408 may adjudicate (e.g., auto-adjudicate) on the executable resolution data based on the acknowledgement message. For example, the adjudication system 408 may include an adjudication system, which may include an adjudication engine configured to adjudicate on the executable resolution data in accordance with an adjudication framework. The adjudication system 408 may further include an electronic portal for facilitating access to one or more functions of the adjudication system and/or overall provider system.

Additionally, or alternatively, in some embodiments, the provider system environment 401 may support a domain diversion system in which the provider user 414 may (e.g., during a call or pre-call) trigger electronic messages to the triage user 402 to request communication via a primary domain, including an electronic message (e.g., text) including a deep link to the executable resolution data and/or to request a session identifier associated with the diagnostic resolution data and/or an image of the diagnostic resolution data.

For example, as depicted in step 5, the triage user 402 may determine to initiate a transaction 415 with the provider user 414 via the secondary domain (e.g., via the telephone). Accordingly, at 415 the provider user 414 may start an interaction with the triage user 402. In some examples, the provider user 414 may trigger transmission of one or more electronic messages to the triage user 402 via the primary domain or secondary domain. For example, a message of the one or more electronic messages may include the link to the webpage 410B, such that the triage user 402 may optionally obtain (e.g., view) the executable resolution data. In some examples, during the transaction 415, the triage user 402 may transmit an acknowledgement message (e.g., an approval message) to the provider user 414 indicating an acceptance of the executable resolution data (or a modified version of the executable resolution data).

In some other examples, the provider system environment 401 may initiate one or more processes for generation of the executable resolution data (e.g., may initiate data ingestion and/or transformation) prior to, or concurrent with, the triage user 402 initiating the transaction 415 with the provider user 414 via the secondary domain (e.g., via the telephone). For example, the triage user 402 may provide a portion of the diagnostic resolution data (e.g., the image 409 at step 2) or other data that is indicative of a portion of the diagnostic resolution data to the provider system environment 401 (e.g., the image 109 at step 2), such that that the provider system environment 401 may initiate one or more processes for generation of the executable resolution data. Additionally, or alternatively, the provider system environment 401 may initiate one or more processes for generation of the executable resolution data based on a user profile associated with the triage user 402. For example, the provider system may maintain a record associated with the particular session, device, fault, or at least one other available identifier which may be supplemented in parallel or asynchronously as data is received. In some embodiments, the provider system may query an internal database for open cases when receiving new inbound diagnostic resolution data.

In some embodiments, at 417, the provider user 414 may complete the interaction with the triage user 402 based on the acknowledgement message. In some embodiments, in response to completing the interaction and/or in response to the adjudication, the provider system environment 401 may transmit the execution instruction set to the triage user 402, for example, to facilitate a resolution for the one or more device faults. In other words, during the interaction between the provider user 414 and the triage user 402, the provider system environment 401 may adjudicate on the executable resolution data, such that the triage user 402 may obtain the executable instructions set during the interaction.

As illustrated in the examples of FIGS. 3 and 4, the techniques described herein may provide a low interaction (e.g., one touch submission) system for automatic transformation of diagnostic resolution data. For example, the provider system environment 301 may obtain diagnostic resolution data in response to receiving a session identifier from a service advisor (or other type of system user). Additionally, the provider system environment 401 may user OCR to obtain diagnostic resolution data in response to receiving an image of the diagnostic resolution data. Accordingly, the techniques and systems described herein reduce or eliminate human interaction (e.g., reduce manual entry of diagnostic resolution data) and also reduce a computer latency associated with generating executable instructions that facilitate resolutions for device faults by minimizing or eliminating translation errors or hangups and by redirecting the process to higher throughput systems (e.g., via the primary domain). The techniques and systems described herein also configure the provider system to be more scalable to handle higher volume, while eliminating duplicative data transmission, ingestion, and/or entry steps. Retrofitting the aforementioned data ingestion and translation system onto an existing adjudication engine may further improve the performance of the adjudication engine and provider system as a whole. The techniques described herein may thereby enable real time or near real time resolution and repair of the device (e.g., by the triage system in response to the execution instruction set). Additionally, in some examples, the techniques described herein provide for scalable automation with confidence level adjustments (e.g., dynamic adjustments to a confidence level threshold associated with adjudication on executable resolution data).

Additionally, as illustrated in the examples of FIGS. 3 and 4, the techniques described herein provide for reduced input from and/or interactions with system users (e.g., the service advisor, the IRF) and enable automatic operation of the aforementioned systems. The techniques described herein provide enable the provider systems (e.g., the provider system environment 301, the provider system environment 401) to obtain diagnostic resolution data from triage systems in real-time without necessitating manual entry of the diagnostic resolution data by system users into the provider systems. For example, the image of the diagnostic resolution data or the session identifier can trigger the provider systems to autonomously process the diagnostic resolution data and generate the execution instructions (e.g., without any additional interaction with the system user). In some embodiments, the provider systems are configured to initiate additional interactions with the system user, for example, based on a failure to map one or more diagnostic identifiers to a respective component or non-component identifier.

Additionally, in some embodiments, the provider systems may autonomously process the diagnostic resolution data and generate the execution instructions without first ingesting information about the system user. For example, while the provider systems may train one or more mapping models to map diagnostic identifiers associated with a particular system user, the provider systems may also train one or more mapping models to identify diagnostic identifiers irrespective of a system user associated with the diagnostic resolution data. In other words, the provider systems may train one or more mapping models with structured historical data, such that, using the one or more trained mapping models, the mapping engine may support mapping of diagnostic identifiers associated with for 1 to N known system users and also support mapping of diagnostic identifiers associated with unknown system users (e.g., N+1, . . . . N+M). In some embodiments, the provider systems may store user profiles for system users, such that the provider systems may identify a system users associated with diagnostic resolution data. Additionally, or alternatively, the provider systems may support one or more pretrained models, which are based on data from the same system users. For example, the provider system may train one or more mapping models on structured historical data associated with multiple users, such that the trained one or more mapping models may be configured to identify and predict one or more patterns associated with users, including known users and unknown users (or known triage systems and unknown triage systems). For example, in some embodiments, the provider system (e.g., the mapping engine included in the provider system) may include a classifier that enables the mapping engine to select a model for an unknown triage system based the on the one or more patterns. In other words, the provider system may include an initial screening layer (e.g., at the input side of the mapping engine) that may classify an unknown user into one or more categories, in which each category may be associated with one or more mapping models. In some embodiments, the provider system may include a set of one or more models for known triage systems and another set of one or more models for unknown triage systems (e.g., a more targeted model trained on narrower data for known triage systems).

In some embodiments, the provider system may train one or more mapping models on structured historical data associated with multiple users/triage systems, multiple devices, and/or multiple device faults, such that the trained one or more mapping models may identify device faults across multiple users/triage systems and multiple types of diagnostic identifiers. That is, the provider system may train the one or more mapping models to identify and predict one or more patterns associated with device faults across multiple users, multiple devices, and/or multiple triage systems. In some embodiments, a trained model may use context information, including metadata and/or information pertaining to related (e.g., adjacent) diagnostic identifiers, to improve an accuracy at which the trained mapping model predicts the executable resolution data.

The techniques for automatic diagnostic resolution data transformation, as described herein, provide for increased flexibility and accuracy associated with resolutions for device faults. For example, by providing multiple mechanisms for data ingestion by a provider system (e.g., transmission of images and/or session identifiers) system users may submit diagnostic resolution information irrespective of a format and/or data type associated with the diagnostic resolution information, and irrespective of a location of the system user (e.g., can submit documents in any form from anywhere). Moreover, system users may submit diagnostic resolution information irrespective of a level of completeness associated with the diagnostic resolution information and/or whether the system user is associated with a user profile in the provider system. Additionally, by retrofitting a preexisting adjudication engine to receive (and adjudicate on) diagnostic resolution data associated with different data types, the provider system supports adjudication functionality for system users irrespective of a data type associated with the system user, as well as improved accuracy of execution instructions.

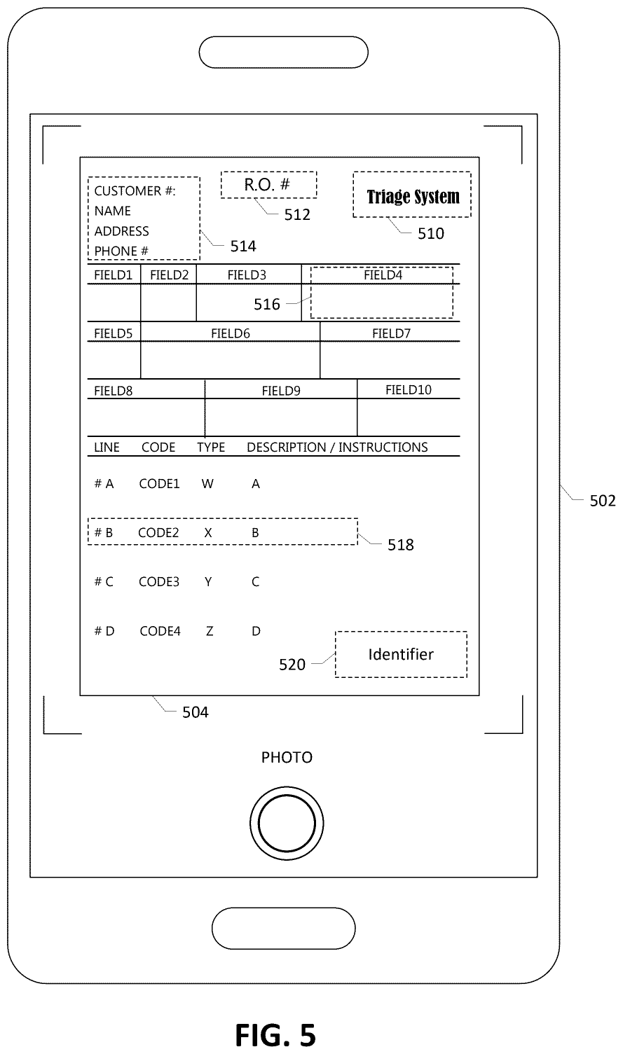

FIG. 5 illustrates diagnostic resolution data in accordance with at least some example embodiments of the present disclosure. Specifically, as depicted, a system user may capture an image 504 of diagnostic resolution data, which has been generated on or otherwise transcribed onto a physical medium, which the provider system may translate into computer readable form prior to transformation into the standardized data type. The diagnostic resolution data includes diagnostic identifiers associated with one or more device faults. As illustrated, in one non-limiting example, the system user may use a user terminal 502 (e.g., mobile device) to capture the image 504 of the physical medium onto which the diagnostic resolution data has been transcribed or generated. As depicted the image 504 includes the diagnostic identifiers, which may be associated with one or more data types.

As depicted, in some embodiments, the diagnostic resolution data (and thus the image 504) includes diagnostic identifiers corresponding to instructions and/or descriptions associated with the session and/or the one or more device faults identified during the session. For example, the image 504 includes a diagnostic identifier 518, which may include (e.g., be indicative of) a diagnostic measurement and/or information derived from a diagnostic measurement (e.g., “multi point inspection” or “engine cranks no start”), analyses or resolution recommendations for resolving a device fault (e.g., “powertrain control module reprogramming”), or prophylactic information (e.g., “door latch freezing concerns”), among other examples.

In some examples, the provider system may identify (e.g., extract) one or more component identifiers (e.g., a part, such as “engine”, “tire”, etc.) and/or non-component identifiers (e.g., labor, such “CPU reprogramming”) based on the diagnostic identifier 518. For example, the provider system may be associated with a standardized data type, in which, in some embodiments, data is categorized explicitly or implicitly as a component identifier or a non-component identifier. In some examples, the provider system (e.g., the mapping engine within the provider system) may determine that the diagnostic identifier 518 is associated with one or more non-component identifiers (e.g., installing the spark plugs, filters, etc.) and/or one or more component identifiers (e.g., spark plugs, filters, etc.) based on using the diagnostic identifier 518 to query for component types. In other words, in response to a query for component types associated with the diagnostic identifier 518, the provider system may identify (e.g., return) component identifiers, non-component identifiers, or both component and non-component identifiers.

As depicted, in some embodiments, the image 504 includes metadata associated with diagnostic resolution information. For example, the image may include a first identifier 510, a second identifier 512, one or more third identifiers 514, a fourth identifier 516, and a fifth identifier 520, which may each correspond to metadata associated with the diagnostic resolution data. In some examples, the metadata may be associated with multiple data types. For example, the first identifier 510 may be in a first data type. In some embodiments, the first identifier is data value corresponding to a first entity (e.g., a triage system) associated with a resolution for a device. In some such embodiments, the first entity may be the system user. The second identifier 512 may be in the first data type of a second data type. For example, the second identifier 512 may be a diagnostic session identifier corresponding to a session for identifying or performing the resolution for the device. In some embodiments, the device is associated with a second entity, which may be an owner of the device and/or an owner of a protection product associated with the device. In some such embodiments, the image 409 includes the one or more third identifiers 514 that include one or more data values associated with the second entity. In some embodiments, the one or more third identifiers 514 are of the same data type. In some other embodiments, the one or more third identifiers 514 are of different data types (e.g., the first data type, the second data type, a third data type). As depicted, in some embodiments, the diagnostic resolution data (and thus the image 504), includes one or more fields that may include metadata. For example, FIELD4 corresponds to a fourth identifier 516. The fourth identifier 516 may correspond to metadata associated with the diagnostic resolution data (e.g., data values corresponding to the device, such as a VIN, or data values corresponding to the session, such a date associated with the session). The fields may be of the same data type or of one or more different data types. The fifth identifier 520 may include (e.g., be indicative of) a transaction of value associated with the session.

The provider system may provide multiple mechanisms for the system user to transmit the diagnostic resolution data to the provider system (e.g., multiple mechanisms for data ingestion). For example, the provider system and/or the system user may use OCR to obtain the diagnostic resolution data from the image 504. For example, the system user may perform OCR to obtain OCR data of the image. In such an example, the system user may transmit the OCR data to the provider system (e.g., via a primary domain). In some other examples, the system user may transmit the image (e.g., via a primary domain) to the provider system and the provider system may perform OCR to obtain the OCR data. Additionally, or alternatively, the system user may transmit the second identifier 512 to the provider system (e.g., via a primary domain or a secondary domain) and the provider system may use the second identifier 512 (e.g., the diagnostic session identifier or other identifier) to obtain the diagnostic resolution data, for example, via one or more API requests. In some examples, by providing multiple mechanisms for data ingestion the provider system may support submission of diagnostic resolution data irrespective of a format and/or data type associated with the diagnostic resolution data, and irrespective of a location of the system user, which may reduce a latency associated with resolving the one or more device faults.

### Example Processes of the Disclosure

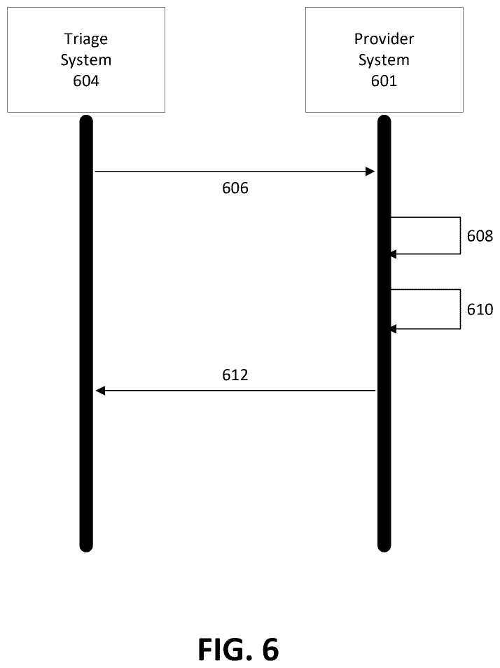

FIG. 6 illustrates a data flow diagram between computing devices performing operations for an example process of automatic transformation of diagnostic resolution data in accordance with at least some example embodiments of the present disclosure. Specifically, as depicted, the data flow includes various operations performed by and/or between a triage system 604 and a provider system 601. The triage system 604 may implement or be implemented by a triage system or a triage system environment illustrated by and described with reference to FIGS. 1-5. Additionally, the provider system 601 may implement or be implemented by a provider system or a provider system environment illustrated by and described with reference to FIGS. 1-5. In the depicted embodiment, the triage system 604 and the provider system 601 support one or more techniques for automatic transformation of diagnostic resolution data, as described herein, which enable reliance on the triage system 604 to be reduced, while still providing accurate execution instructions based on the diagnostic resolution data. For example, FIG. 6 illustrates a flowchart depicting operations of an example process for automatic transformation of diagnostic resolution data in accordance with at least some example embodiments of the present disclosure. The triage system 604 and/or the provider system 601, in some embodiments, are embodied by the apparatus 200 illustrated by and described with reference to FIG. 2.

The process begins at operation 606. At operation 606, the provider system 601 includes means, such as the data ingestion and transformation circuitry 210, communications circuitry 208, input/output circuitry 206, processor 202, and/or the like, or a combination thereof, to receive, from the triage system 604, diagnostic resolution data comprising one or more first diagnostic identifiers associated with one or more device faults or data indicative of such diagnostic resolution data, such as image data. The provider system 601 may receive the diagnostic resolution data (e.g., the one or more diagnostic identifiers included in the diagnostic resolution data) via one or more mechanisms. For example, the provider system 601 may receive an image comprising the one or more first diagnostic identifiers. In such an example, the provider system 601 may generate the diagnostic resolution data from the image using OCR. Additionally, or alternatively, the provider system 601 may receive (or otherwise obtain) a diagnostic session identifier associated with the one or more first diagnostic identifiers. In some examples, the provider system 601 may receive an indication of a diagnostic session identifier or an image associated with the diagnostic session identifier. In some such examples, the provider system may transmit an API request to an endpoint of the triage system 604 and receive the diagnostic resolution data in response to request. In some examples, the provider system 601 may automatically trigger receipt of the diagnostic resolution data in response to receiving an indication of the diagnostic session identifier.

At operation 608, the provider system 601 includes means, such as the data ingestion and transformation circuitry 210, communications circuitry 208, input/output circuitry 206, processor 202, and/or the like, or a combination thereof, to transform, via a mapping engine comprising a trained mapping model, the diagnostic resolution data into executable resolution data by mapping the one or more first diagnostic identifiers to at least one or more component identifiers. In some examples, the provider system 601 may train a mapping model using structured historical diagnostic resolution data comprising a plurality of historical diagnostic identifiers and historical executable resolution data comprising a plurality of component identifiers associated with the structured historical diagnostic resolution data to obtain the trained mapping model in accordance with any of the various embodiments discussed herein. In some examples, the provider system 601 may obtain the structured historical diagnostic resolution data (or a portion thereof) from one or more external service systems and/or one or more triage systems. The trained mapping model may, in some embodiments, include one or more NLP models. In some such embodiments, transformation of the diagnostic resolution data into the executable resolution data is based on applying the diagnostic resolution data to at least one NLP model using the mapping engine.

At optional operation 610, the provider system 601 includes means, such as the adjudication circuitry 212, communications circuitry 208, input/output circuitry 206, processor 202, and/or the like, or a combination thereof, to generate an execution instruction set, via an adjudication engine comprising an adjudication framework, based on the one or more component identifiers. In some examples, the adjudication engine is a preexisting adjudication engine (e.g., a legacy adjudication engine associated with a standardized data type). In some such examples, the mapping engine is configured to retrofit the preexisting adjudication engine to receive the diagnostic resolution data associated with a multiple data types without modifying the preexisting adjudication engine (e.g., as a data conditioner inserted between the triage system(s) and the adjudication engine(s)).

At operation 612, the provider system 601 includes means, such as the data ingestion and transformation circuitry 210, communications circuitry 208, input/output circuitry 206, processor 202, and/or the like, or a combination thereof, to transmit the execution instruction set to facilitate a resolution for the one or more device faults (e.g., by the triage system 604). In some examples, the execution instructions set is based on a system user. In some examples, at least one component identifier may be indicative of a system user, or a pattern associated with the component identifier may be indicative of the system user. In some such examples, the provider system 601 may identify the system user that corresponds to a device associated with the one or more device faults based at a comparison of user profile data with the at least one component identifier of the one or more component identifiers. In such an example, the provider system 601 may identify a protection product associated with the user and, as such, may generate execution instructions in accordance with the protection product (e.g., based on the system user). In some examples, by transforming the diagnostic resolution data into the executable resolution data, the provider system 601 improves an accuracy associated with the adjudication engine and the execution instructions set.

Although the foregoing description of FIGS. 1-6, and the associated drawing, describe example functions of triage systems in the context of a single triage system, it should be appreciated that triage systems may provide for different combinations of functions that may be performed by one or multiple systems without departing from the scope of the appended claims. In this regard, for example, different combinations of functions than those explicitly described above are also contemplated as may be set forth in some of the appended claims. In one non-limiting example, a triage system illustrated by and described with reference to FIGS. 1-6 may provide for functions performed by a customer, a vehicle dealership, a vehicle manufacturer, a service advisor, a dealer management system, an independent repair facility, a third-party supplier, and/or the like.

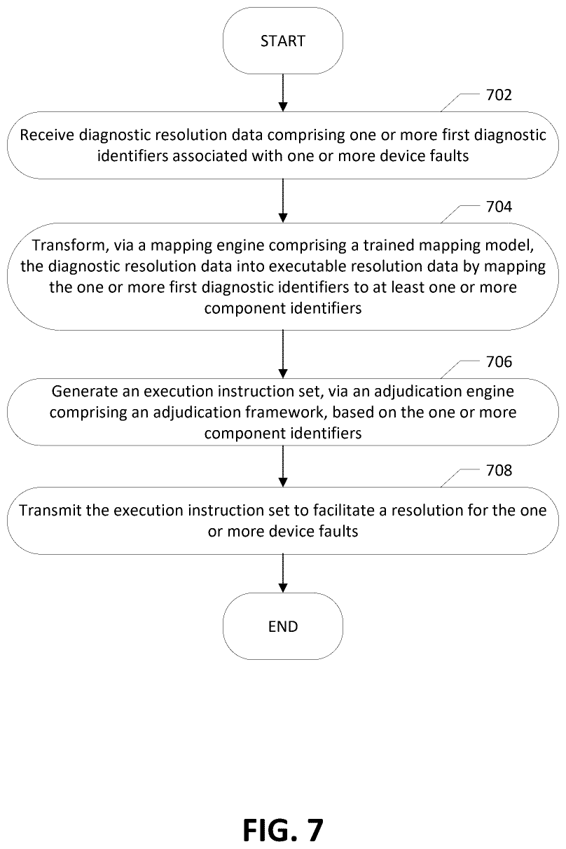

FIG. 7 illustrates a flowchart depicting operations for an example process of automatic transformation of diagnostic resolution data. Specifically, FIG. 7 illustrates operations of an example process for automatic transformation of diagnostic resolution data in accordance with at least some example embodiments of the present disclosure. The process may be implemented by a provider system or a provider system environment illustrated by and described with reference to FIGS. 1-6. The provider system, in some embodiments, is embodied by the apparatus 200 illustrated by and described with reference to FIG. 2

In some embodiments, the process may begin after one or more operations of another process and/or sub-process. For example, in some embodiments, the process depicted and described with respect to FIG. 7 begins after one or more operations performed by a triage system and/or one or more operations performed by the provider system. In some embodiments, the flow ends upon completion of the operations as depicted and described with respect to FIG. 7. In some other embodiments, the flow ends upon completion of one or more other operations performed, for example, by the provider system or the triage system.

At operation 702, the apparatus 200 includes means, such as the data ingestion and transformation circuitry 210, communications circuitry 208, input/output circuitry 206, processor 202, and/or the like, or a combination thereof, to receive diagnostic resolution data comprising one or more first diagnostic identifiers associated with one or more device faults.

At optional operation 704, the apparatus 200 includes means, such as the data ingestion and transformation circuitry 210, communications circuitry 208, input/output circuitry 206, processor 202, and/or the like, or a combination thereof, to transform, via a mapping engine comprising a trained mapping model, the diagnostic resolution data into executable resolution data by mapping the one or more first diagnostic identifiers to at least one or more component identifiers.

At operation 706, the apparatus 200 includes means, such as the adjudication circuitry 212, communications circuitry 208, input/output circuitry 206, processor 202, and/or the like, or a combination thereof, to generate an execution instruction set, via an adjudication engine comprising an adjudication framework, based on the one or more component identifiers.

At optional operation 708, the apparatus 200 includes means, such as the data ingestion and transformation circuitry 210, communications circuitry 208, input/output circuitry 206, processor 202, and/or the like, or a combination thereof, to transmit the execution instruction set to facilitate a resolution for the one or more device faults.

### CONCLUSION

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random-access memory or both. The essential elements of a computer are a processor for performing actions in accordance with instructions and one or more memory devices for storing instructions and data. A computer may also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

### Non-Limiting Example Embodiments of the Disclosure

Having described various aspects of the innovations, it will be appreciated that various embodiments are described herein. The subject matter described herein includes, without limitation, the following specific embodiments. These embodiments are merely examples and should not be construed as limiting the scope of the disclosure. It will be appreciated that the embodiments in some aspects are freely combinable. In other aspects of the present disclosure, each embodiment is independent from other embodiments described.
Embodiment 1. A computer-implemented method comprising: receiving diagnostic resolution data comprising one or more first diagnostic identifiers associated with one or more device faults; transforming, via a mapping engine comprising a trained mapping model, the diagnostic resolution data into executable resolution data by mapping the one or more first diagnostic identifiers to at least one or more component identifiers; generating an execution instruction set, via an adjudication engine comprising an adjudication framework, based on the one or more component identifiers; and transmitting the execution instruction set to facilitate a resolution for the one or more device faults.
Embodiment 2. The computer-implemented method of claim 1, further comprising: receiving an image comprising the one or more first diagnostic identifiers; and generate the diagnostic resolution data from the image using optical character recognition.
Embodiment 3. The computer-implemented method of claim 1, further comprising: transmitting an application programming interface request to an endpoint of a first computing system associated with generating the one or more first diagnostic identifiers; and receiving the diagnostic resolution data in response to the application programming interface request to the endpoint of the first computing system.
Embodiment 4. The computer-implemented method of claim 3, further comprising: obtaining a diagnostic session identifier associated with the one or more first diagnostic identifiers, wherein the application programming interface request comprises at least the diagnostic session identifier.
Embodiment 5. The computer-implemented method of claim 1, further comprising: receiving, from a system user, an indication of a diagnostic session identifier or an image associated with a diagnostic session associated with the one or more device faults; and automatically triggering receipt of the diagnostic resolution data in response to receipt of the indication.
Embodiment 6. The computer-implemented method of claim 1, further comprising: receiving, via a second domain, a request to initiate a transaction from a system user associated with a device experiencing the one or more device faults; and responsive to the request, triggering transmission of one or more electronic messages to the system user via a first domain or the second domain, wherein the one or more electronic messages comprise instructions pertaining to initiation of the transaction, and wherein reception of the diagnostic resolution data is based at least in part on transmission of the one or more electronic messages.
Embodiment 7. The computer-implemented method of claim 6, wherein at least one electronic message of the one or more electronic messages comprises a deep link transmitted to a computing device associated with the system user, the computing device being different than the device experiencing the one or more device faults.
Embodiment 8. The computer-implemented method of claim 6, wherein the computer program instructions, when executed by the one or more processors, are configured to cause the system to: trigger transmission of status information to the system user via the second domain, wherein the status information pertains to a status of the transaction.
Embodiment 9. The computer-implemented method of claim 1, further comprising: transmitting a request to a system user associated with a device experiencing the one or more device faults based at least in part on a failure to map at least one diagnostic identifier of the one or more first diagnostic identifiers to a respective component identifier; receiving a second diagnostic identifier from the system user, the second diagnostic identifier being mappable onto the respective component identifier; and substituting the at least one diagnostic identifier with the second diagnostic identifier in the diagnostic resolution data.
Embodiment 10. The computer-implemented method of claim 1, further comprising: identifying a system user that corresponds to a device associated with the one or more device faults based at least in part on a comparison of user profile data with at least one component identifier of the one or more component identifiers, wherein the execution instruction set is based at least in part on the system user.
Embodiment 11. The computer-implemented method of claim 1, wherein the diagnostic resolution data comprises at least one of the following: data associated with resolving the one or more device faults, data associated with attempting to resolve the one or more device faults, data associated with attempting to prevent an occurrence of the one or more device faults, data associated with preventing one or more effects of the one or more device faults, or data associated with mitigate one or more effects of the one or more device faults.
Embodiment 12. The computer-implemented method of claim 1, wherein the one or more first diagnostic identifiers are mapped to the one or more component identifiers and one or more non-component identifiers.
Embodiment 13. The computer-implemented method of claim 12, wherein the one or more component identifiers correspond to one or more components of at least one device associated with the one or more device faults, and the one or more non-component identifiers correspond to at least one of the following: one or more operations performed in accordance with a resolution of the one or more device faults, one or more first parameters of a first system user associated with the at least one device, or one or more second parameters of a second system user associated with the resolution for the one or more device faults.
Embodiment 14. The computer-implemented method of claim 1, wherein the diagnostic resolution data comprises vehicular diagnostic resolution data generated based on one or more diagnostic measurements associated with a vehicle.
Embodiment 15. The computer-implemented method of claim 1, further comprising: training a mapping model using structured historical diagnostic resolution data comprising a plurality of historical diagnostic identifiers, and historical executable resolution data comprising a plurality of component identifiers associated with the structured historical diagnostic resolution data to obtain the trained mapping model.
Embodiment 16. The computer-implemented method of claim 1, wherein the trained mapping model comprises at least one natural language processing model, and wherein transformation of the diagnostic resolution data into the executable resolution data is based at least in part on applying the diagnostic resolution data to the at least one natural language processing model using the mapping engine.
Embodiment 17. The computer-implemented method or claim 1, wherein the diagnostic resolution data comprises a plurality of diagnostic resolution data sets associated with a plurality of data types, and wherein the mapping engine maps each diagnostic resolution data set of the plurality of diagnostic resolution data sets to a plurality of executable resolution data sets in accordance with a respective data type of the plurality of data types.
Embodiment 18. The computer-implemented method of claim 1, wherein each component identifier of the one or more component identifiers are associated with a same data type, and where in the one or more device faults correspond to a first device.
Embodiment 19. The computer-implemented method of claim 1, wherein the adjudication engine comprises a preexisting adjudication engine, and wherein the mapping engine is configured to retrofit the preexisting adjudication engine to receive the diagnostic resolution data associated with a plurality of data types without modifying the preexisting adjudication engine.

Many modifications and other embodiments of the disclosure set forth herein will come to mind to one skilled in the art to which this disclosure pertains having the benefit of the teachings presented in the foregoing description and the associated drawings. Therefore, it is to be understood that the embodiments are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A system comprising at least one non-transitory computer readable medium comprising computer program instructions, the computer program instructions, when executed by one or more processors, are configured to cause the system to:
receive diagnostic resolution data comprising one or more first diagnostic identifiers associated with one or more device faults;
transform, via a mapping engine comprising a trained mapping model, the diagnostic resolution data into executable resolution data by mapping the one or more first diagnostic identifiers to at least one or more component identifiers;
generate an execution instruction set, via an adjudication engine comprising an adjudication framework, based on the one or more component identifiers; and
transmit the execution instruction set to facilitate a resolution for the one or more device faults.

2. The system of claim 1, wherein, the computer program instructions, when executed by the one or more processors, are configured to cause the system to receive the diagnostic resolution data by:
receive an image comprising the one or more first diagnostic identifiers; and
generate the diagnostic resolution data from the image using optical character recognition.

3. The system of claim 1, wherein, the computer program instructions, when executed by the one or more processors, are configured to cause the system to receive the diagnostic resolution data by:
transmit an application programming interface request to an endpoint of a first computing system associated with generating the one or more first diagnostic identifiers; and
receive the diagnostic resolution data in response to the application programming interface request to the endpoint of the first computing system.

4. The system of claim 3, wherein the computer program instructions, when executed by the one or more processors, are configured to cause the system to:
obtain a diagnostic session identifier associated with the one or more first diagnostic identifiers, wherein the application programming interface request comprises at least the diagnostic session identifier.

5. The system of claim 1, wherein the computer program instructions, when executed by the one or more processors, are configured to cause the system to:
receive, from a system user, an indication of a diagnostic session identifier or an image associated with a diagnostic session associated with the one or more device faults; and
automatically trigger receipt of the diagnostic resolution data in response to receipt of the indication.

6. The system of claim 1, wherein the computer program instructions, when executed by the one or more processors, are configured to cause the system to:
receive, via a second domain, a request to initiate a transaction from a system user associated with a device experiencing the one or more device faults; and
responsive to the request, trigger transmission of one or more electronic messages to the system user via a first domain or the second domain, wherein the one or more electronic messages comprise instructions pertaining to initiation of the transaction, and wherein reception of the diagnostic resolution data is based at least in part on transmission of the one or more electronic messages.

7. The system of claim 6, wherein at least one electronic message of the one or more electronic messages comprises a deep link transmitted to a computing device associated with the system user, the computing device being different than the device experiencing the one or more device faults.

8. The system of claim 6, wherein the computer program instructions, when executed by the one or more processors, are configured to cause the system to:
trigger transmission of status information to the system user via the second domain,
wherein the status information pertains to a status of the transaction.

9. The system of claim 1, wherein the computer program instructions, when executed by the one or more processors, are configured to cause the system to:
transmit a request to a system user associated with a device experiencing the one or more device faults based at least in part on a failure to map at least one diagnostic identifier of the one or more first diagnostic identifiers to a respective component identifier;
receive a second diagnostic identifier from the system user, the second diagnostic identifier being mappable onto the respective component identifier; and
substitute the at least one diagnostic identifier with the second diagnostic identifier in the diagnostic resolution data.

10. The system of claim 1, wherein the computer program instructions, when executed by the one or more processors, are configured to cause the system to:
identify a system user that corresponds to a device associated with the one or more device faults based at least in part on a comparison of user profile data with at least one component identifier of the one or more component identifiers, wherein the execution instruction set is based at least in part on the system user.

11. The system of claim 1, wherein the diagnostic resolution data comprises at least one of the following: data associated with resolving the one or more device faults, data associated with attempting to resolve the one or more device faults, data associated with attempting to prevent an occurrence of the one or more device faults, data associated with preventing one or more effects of the one or more device faults, or data associated with mitigate one or more effects of the one or more device faults.

12. The system of claim 1, wherein the one or more first diagnostic identifiers are mapped to the one or more component identifiers and one or more non-component identifiers.

13. The system of claim 12, wherein:
the one or more component identifiers correspond to one or more components of at least one device associated with the one or more device faults, and
the one or more non-component identifiers correspond to at least one of the following:
one or more operations performed in accordance with a resolution of the one or more device faults, one or more first parameters of a first system user associated with the at least one device, or one or more second parameters of a second system user associated with the resolution for the one or more device faults.

14. The system of claim 1, wherein the diagnostic resolution data comprises vehicular diagnostic resolution data generated based on one or more diagnostic measurements associated with a vehicle.

15. A computer-implemented method comprising:
receiving diagnostic resolution data comprising one or more first diagnostic identifiers associated with one or more device faults;
transforming, via a mapping engine comprising a trained mapping model, the diagnostic resolution data into executable resolution data by mapping the one or more first diagnostic identifiers to at least one or more component identifiers;
generating an execution instruction set, via an adjudication engine comprising an adjudication framework, based on the one or more component identifiers; and
transmitting the execution instruction set to facilitate a resolution for the one or more device faults.

16. The method of claim 15, further comprising:
training a mapping model using structured historical diagnostic resolution data comprising a plurality of historical diagnostic identifiers, and historical executable resolution data comprising a plurality of component identifiers associated with the structured historical diagnostic resolution data to obtain the trained mapping model.

17. The method of claim 15, wherein the trained mapping model comprises at least one natural language processing model, and wherein transformation of the diagnostic resolution data into the executable resolution data is based at least in part on applying the diagnostic resolution data to the at least one natural language processing model using the mapping engine.

18. The method of claim 15, wherein the diagnostic resolution data comprises a plurality of diagnostic resolution data sets associated with a plurality of data types, and wherein the mapping engine maps each diagnostic resolution data set of the plurality of diagnostic resolution data sets to a plurality of executable resolution data sets in accordance with a respective data type of the plurality of data types.

19. The method of claim 18, wherein each component identifier of the one or more component identifiers are associated with a same data type, and where in the one or more device faults correspond to a first device.

20. The method of claim 15, wherein the adjudication engine comprises a preexisting adjudication engine, and wherein the mapping engine is configured to retrofit the preexisting adjudication engine to receive the diagnostic resolution data associated with a plurality of data types without modifying the preexisting adjudication engine.
